(19) United States
(12) Patent Application Publication
(10) Pub. No.: US 2026/0059208 A1
(43) Pub. Date: Feb. 26, 2026

(54) IMAGING DEVICE AND METHOD

(71) Applicant: Samsung Electronics Co., Ltd., Suwon-si (KR)

(72) Inventor: Masumi Shiono, Yokohama (JP)

(21) Appl. No.: 19/307,421

(22) Filed: Aug. 22, 2025

(30) Foreign Application Priority Data
Aug. 23, 2024 (JP) 2024-141774

(51) Int. Cl. H04N 25/616; H04N 25/47; H04N 25/707; H04N 25/773

(52) U.S. Cl. CPC H04N 25/616; H04N 25/47; H04N 25/707; H04N 25/773

(57) ABSTRACT

An imaging device includes a pixel array including a first photodiode (PD) pixel and a single-photon avalanche diode (SPAD) pixel corresponding to the PD pixel and a pixel signal adjustment operation circuit configured to generate a corrected output signal of the first PD pixel by performing a noise reduction operation according to illuminance, based on an output signal of the first PD pixel and an output signal of the first SPAD pixel. An imaging method includes generating a first output signal by the first PD pixel based on light received by the first PD pixel; generating a second output signal by the first SPAD pixel based on light received by the first SPAD pixel; and generating the corrected output signal of the first PD pixel by performing the noise reduction operation.

### CROSS-REFERENCE TO RELATED APPLICATION

This application is based on and claims priority under 35 U.S.C. § 119 to Japanese Patent Application No. JP 2024-141774, filed on Aug. 23, 2024, in the Japan Patent Office, the disclosure of which is incorporated by reference herein in its entirety.

### BACKGROUND

Aspects of the inventive concept relate to an imaging device.

Recently, imaging devices (such as image sensors) using a single-photon avalanche diode (SPAD) as a photoelectric conversion element have been attracting growing attention. Because a SPAD outputs a count corresponding to the number of incident photons, imaging devices have high sensitivity even in a low-illuminance environment In addition, imaging devices may capture images without saturation even at high illuminance by increasing the size of a counter, thereby having a wide dynamic range, although there are limitations in integration. A prior art document, JP 2023-90043 A, discloses that a defective pixel occurring in a first imaging unit using a SPAD sensor is corrected with a pixel signal of a second imaging unit using a complementary metal-oxide semiconductor (CMOS) sensor. Because two imaging units are required, a configuration is complex. The prior art document relates to correction of defective image quality occurring in a SPAD sensor and does not address overall image quality.

### SUMMARY

Aspects of the inventive concept provide an imaging device having satisfactory image quality characteristics under imaging conditions ranging from low illuminance to high illuminance.

According to an aspect of the inventive concept, an imaging device includes a pixel array including a first photodiode (PD) pixel and a single-photon avalanche diode (SPAD) pixel corresponding to the PD pixel, and a pixel signal adjustment operation circuit configured to generate a corrected output signal of the first PD pixel by performing a noise reduction operation according to illuminance, based on an output signal of the first PD pixel and an output signal of the first SPAD pixel.

A low illuminance may range from about 10 lux to about 100 lux.

The pixel signal adjustment operation circuit may be further configured to set a noise reduction coefficient according to the illuminance based on a user input and calculate the corrected output signal of the PD pixel according to Equation 1 using the noise reduction coefficient according to the illuminance:

V50=((V10×gr−V20)×rn+V20)/gr, [Equation 1]

wherein V50 is the corrected output signal, V10 is an output signal value of the PD pixel, V20 is an output signal value of the SPAD pixel, gr is a gain coefficient used to match scales of the output signals, and rn is the noise reduction coefficient.

According to an aspect of the inventive concept, a method includes generating a first output signal by a first photodiode (PD) pixel of a pixel array based on light received by the first PD pixel; generating a second output signal by a first single-photon avalanche diode (SPAD) pixel of the pixel array based on light received by the first SPAD pixel; and generating a corrected output signal of the first PD pixel by performing a noise reduction operation according to illuminance, based on the first output signal of the first PD pixel and the first output signal of the first SPAD pixel.

### BRIEF DESCRIPTION OF THE DRAWINGS

Embodiments will be more clearly understood from the following detailed description taken in conjunction with the accompanying drawings in which:

FIG. 1 is a block diagram illustrating an imaging device according to an embodiment;

FIG. 2A is a diagram illustrating a pixel array according to an embodiment;

FIG. 2B is a diagram illustrating a pixel block according to an embodiment;

FIG. 3 is a block diagram illustrating an imaging device according to an embodiment;

FIG. 4A is a diagram illustrating output characteristics of a photodiode (PD) pixel, according to an embodiment;

FIG. 4B is a diagram illustrating the range of use of a noise reduction coefficient in low to high illuminance, according to an embodiment;

FIG. 5 is a diagram illustrating noise reduction operation processing according to an embodiment;

FIG. 6 illustrates mapping information showing the relationship between illuminance of an operation parameter and a noise reduction coefficient, according to an embodiment;

FIG. 7 is a diagram illustrating the relationship between an output signal of a pixel and a noise reduction operation in a low-illuminance imaging environment, according to an embodiment;

FIG. 8 is a diagram illustrating specific examples of output signals in a low-illuminance imaging environment, according to an embodiment;

FIG. 9 is a diagram illustrating a noise reduction operation in a low-illuminance imaging environment, according to an embodiment;

FIG. 10 is a diagram illustrating the relationship between an output signal of a pixel and a noise reduction operation in a high-illuminance imaging environment, according to an embodiment;

FIG. 11 is a diagram illustrating a specific example of a noise reduction operation according to an embodiment;

FIG. 12 is a diagram illustrating a specific example of a noise reduction operation according to an embodiment;

FIG. 13 is a diagram illustrating a specific example of a noise reduction operation according to an embodiment;

FIG. 14 is a diagram illustrating a specific example of a noise reduction operation according to an embodiment;

FIG. 15 is a diagram illustrating a specific example of a noise reduction operation according to an embodiment;

FIG. 16 is a diagram illustrating a specific example of a noise reduction operation according to an embodiment;

FIG. 17 is a diagram illustrating a specific example of a noise reduction operation according to an embodiment;

FIG. 18 is a diagram illustrating a specific example of a noise reduction operation according to an embodiment;

FIG. 19 is a diagram illustrating a specific example of a noise reduction operation according to an embodiment;

FIG. 20 is a block diagram illustrating an imaging device according to an embodiment;

FIG. 21 is a diagram illustrating an integrated output signal generated using a distance ratio, according to an embodiment;

FIG. 22 is a diagram illustrating an example of a pixel array according to an embodiment;

FIG. 23 is a diagram illustrating an example of a pixel array according to an embodiment;

FIG. 24 is a diagram illustrating an example of a pixel array according to an embodiment;

FIG. 25 is a diagram illustrating an example of a pixel array according to an embodiment;

FIG. 26 is a diagram illustrating an example of a pixel array according to an embodiment;

FIG. 27 is a diagram illustrating an example of a pixel array according to an embodiment;

FIG. 28 is a diagram illustrating an example of a pixel array according to an embodiment;

FIG. 29 is a diagram illustrating an example of a pixel array according to an embodiment;

FIG. 30 is a diagram illustrating an example of a pixel array according to an embodiment;

FIG. 31 is a diagram illustrating an example of a pixel array according to an embodiment;

FIG. 32 is a diagram illustrating an example of a pixel array according to an embodiment;

FIG. 33 is a diagram illustrating an example of a pixel array according to an embodiment;

FIG. 34 is a diagram illustrating the relationship between an output signal of a pixel and a noise reduction operation in a low-illuminance imaging environment, according to an embodiment;

FIG. 35 is a diagram illustrating the relationship between an output signal of a pixel and a noise reduction operation in a low-illuminance imaging environment, according to an embodiment;

FIG. 36 is a diagram illustrating a pixel array of an imaging device, according to an embodiment;

FIG. 37 is a diagram illustrating an image generation process according to an embodiment;

FIG. 38 is a diagram illustrating the usage ratio of various pixels in different illuminance;

FIG. 39 is a diagram illustrating a pixel array of an imaging device, according to an embodiment;

FIG. 40 is a diagram illustrating the usage ratio of each pixel used for movement sensing and update rate determination, according to an embodiment;

FIG. 41 is a flowchart of a process according to an embodiment;

FIG. 42 is a diagram illustrating a process of changing a frame rate according to event detection; and

FIG. 43 is a diagram illustrating an imaging device and a pixel array, according to an embodiment.

### DETAILED DESCRIPTION OF THE EMBODIMENTS

Hereinafter, embodiments are described in detail with reference to the accompanying drawings. However, the scope of the inventive concept is not limited to these embodiments. In the drawings, like reference characters or numerals denote like elements, and the size of each element is expressed in a different ratio from the actual size for clarity and convenience of description. The embodiments described below are just examples, and various modifications may be made therein.

The expression “on” or “on the top of” may include a case where one element is in contact with another element and a case where one element is arranged without being in contact with another element.

The singular forms are intended to include the plural forms as well, unless the context clearly indicates otherwise. When a portion “includes” or “has” an element, another element may be further included, rather than excluding the existence of the other element, unless otherwise described.

Ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first” in a particular claim) may be referenced elsewhere without an ordinal number or with a different ordinal number (e.g., “second” in the specification or another claim).

The use of any and all examples or language (e.g., “such as”) provided herein is intended merely to better illuminate embodiments and does not pose a limitation on the scope of embodiments unless otherwise claimed.

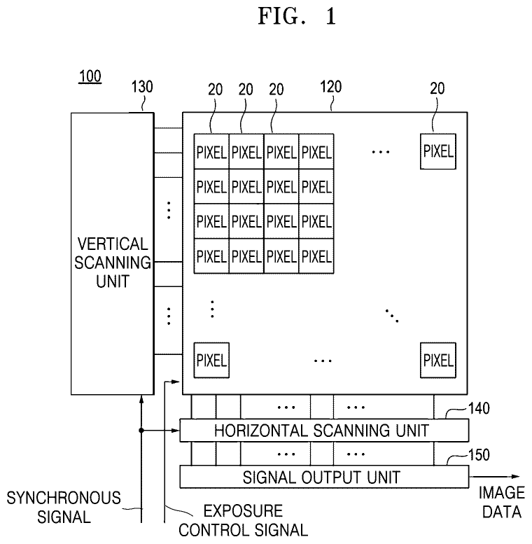

FIG. 1 is a block diagram illustrating an imaging device according to an embodiment. The imaging device may be, for example, an image sensor that may be part of an electronic device such as a camera, a mobile phone including a camera, a tablet, etc.

Referring to FIG. 1, an imaging device 100 may include a pixel array 120, a vertical scanning unit 130, a horizontal scanning unit 140, and a signal output unit 150. The pixel array 120 may include a plurality of pixels 20 in a row direction (hereinafter, referred to as an X direction or a horizontal direction) and a column direction (hereinafter, referred to as a Y direction or a vertical direction). All (e.g., several millions or more) pixels 20 of the imaging device 100 may be included in the pixel array 120. As described below, the pixel array 120 may include a single-photon avalanche diode (SPAD) pixel and a complementary metal-oxide semiconductor (CMOS)-type photodiode (PD) pixel, which is a general pixel different from the SPAD pixel, wherein a SPAD is a first-type photoelectric conversion element, and a PD is a second-type photoelectric conversion element. Here, apart from a SPAD pixel, a pixel composed of a PD, such as a CMOS-type PD, according to the related art is simply referred to as a PD pixel. A PD pixel may be different from a SPAD pixel in terms of noise characteristics. The imaging device 100 may be controlled by a controller or processor, which may include a semiconductor chip such as a logic chip, and which includes various logic circuits and other hardware components as well as firmware and/or software. The various signals and functions described herein may be generated and/or executed based on the hardware, software, and firmware configured to control and receive image data from the imaging device. Items described as “units” for performing these functions, and certain components, such as pixel signal adjustment operation circuit 27, may be formed of one or more of these hardware, firmware, and/or software components.

A synchronous signal may be input to each of the vertical scanning unit 130 and the horizontal scanning unit 140, and an exposure control signal may be input to the pixel array 120. Rows Y may be sequentially selected by the vertical scanning unit 130 and columns X may be sequentially selected by the horizontal scanning unit 140 so that the pixels 20 may be sequentially selected in an XY address manner. A pixel signal (or a count signal) of a selected pixel 20 may be output to the signal output unit 150 through a signal line. The signal output unit 150 may integrate the pixels signals of the pixels 20, which are output to signal lines, and may output image data to an external recording medium or a signal processor.

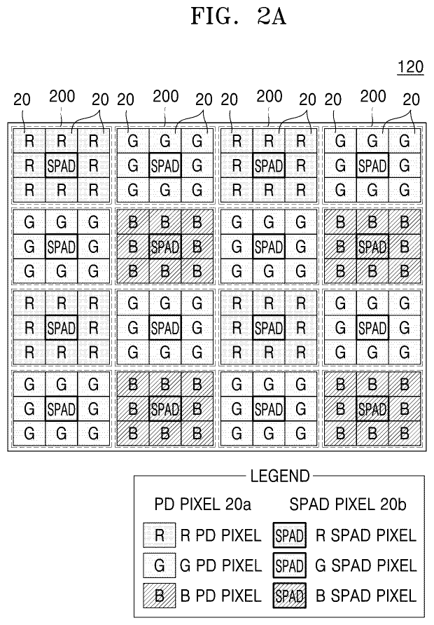

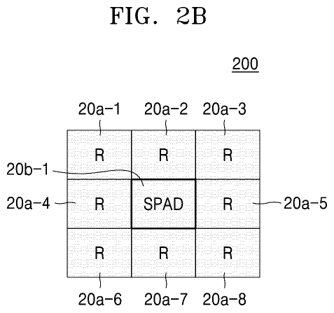

FIG. 2A is a diagram illustrating a pixel array according to an embodiment. FIG. 2B is a diagram illustrating a pixel block according to an embodiment. The pixel array of FIG. 2A may be applied to the imaging device 100 of FIG. 1. FIG. 2B illustrates one of the pixel blocks in FIG. 2A.

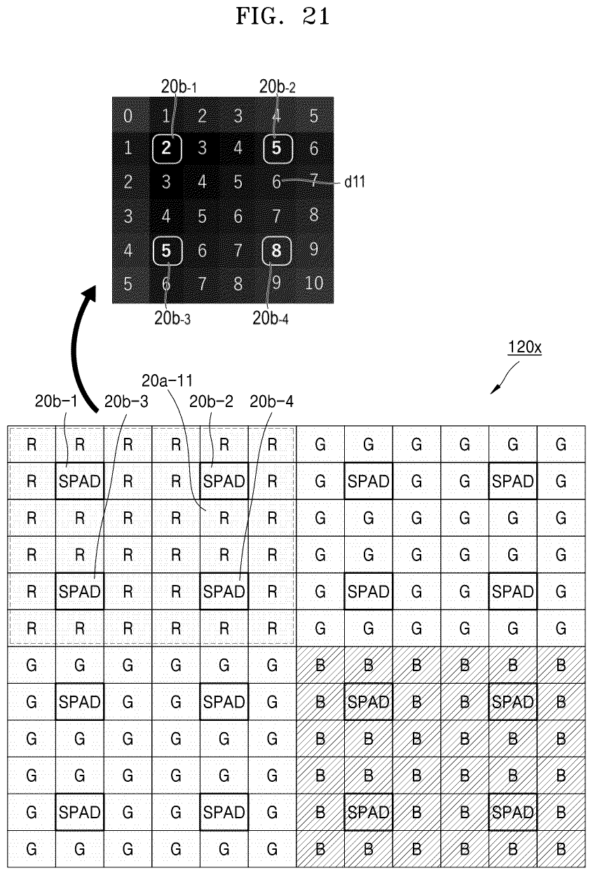

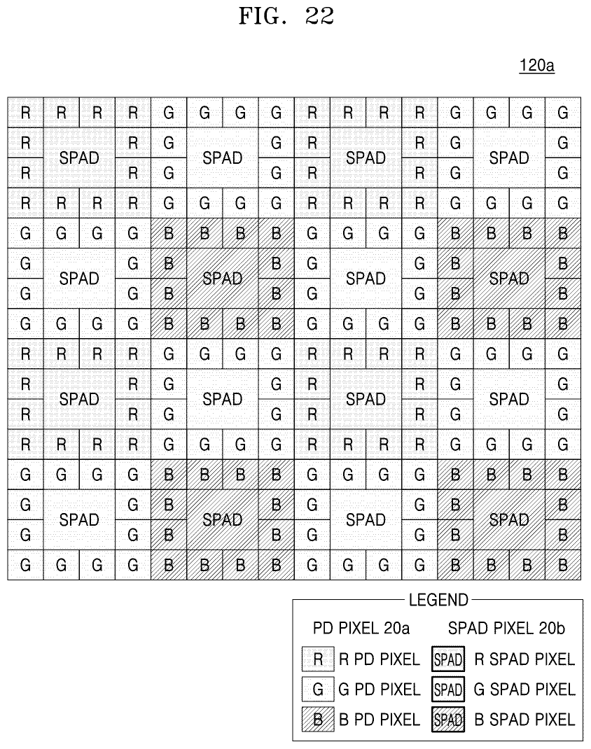

Referring to FIG. 2A, a pixel array 120 may include a plurality of pixel blocks 200 arranged in a two-dimensional (2D) grid (in row and column directions) on a plane viewed in a direction perpendicular to a substrate surface of the imaging device 100. For example, the pixel array 120 may include a plurality of pixel blocks 200. In FIG. 2A, only some of pixel blocks are denoted by reference numeral 200, and only some of pixels are denoted by reference numeral 20. Although the pixel array 120 may include, for example, several million or more pixels 20, only some pixels 20 are shown in FIG. 2A. The same is applied to FIGS. 21 and 22.

The pixels 20 may be divided into the pixel blocks 200 each having a certain size. Each of the pixel blocks 200 may include a SPAD pixel and a PD pixel. Each pixel block 200 may include at least one SPAD pixel and a plurality of PD pixels. For example, one pixel block 200 may include a SPAD pixel 20b-1 and eight PD pixels 20a-1 to 20a-8. The SPAD pixel 20b-1 may be at the center of the pixel block 200, and the PD pixels 20a-1 to 20a-8 may surround the SPAD pixel 20b-1.

Referring to FIGS. 2A and 2B, one SPAD pixel 20b-1 of a SPAD type and eight PD pixels 20a-1 to 20a-8 of a CMOS type, which surround the SPAD pixel 20b-1, may be included in one pixel block 200. Hereinafter, when the PD pixels 20a-1 to 20a-8 are not distinguished from one another, the PD pixels 20a-1 to 20a-8 may be generically referred to PD pixels 20a (the same is applied to SPAD pixels 20b). In addition, when a PD pixel 20a (hereinafter, simply referred to as a pixel 20a) is not distinguished from a SPAD pixel 20b (hereinafter, simply referred to as a pixel 20b in some occasions), the PD pixel 20a and the SPAD pixel 20b may be generically named pixels 20. Therefore, the term “pixel” may be used to refer to a SPAD pixel or a PD pixel, and the term “PD pixel” may be used to refer to any one of the PD pixels of a pixel block 200.

The PD pixels 20a of the pixel block 200 of FIG. 2B may correspond to one SPAD pixel 20b. For example, the pixel block 200 may include only one SPAD pixel 20b. Referring to FIG. 2A, each SPAD pixel 20b may correspond to (or may be covered with) one of red (R), green (G), and blue (B) color filters. In FIGS. 2A and 2B (also in FIG. 21 described below), for each pixel group 200, only the PD pixels 20a are marked with R, G, or B in correspondence to a color filter, as shown in the legend, but the same color filter for the pixel group 200 is used for the corresponding SPAD pixel 20b.

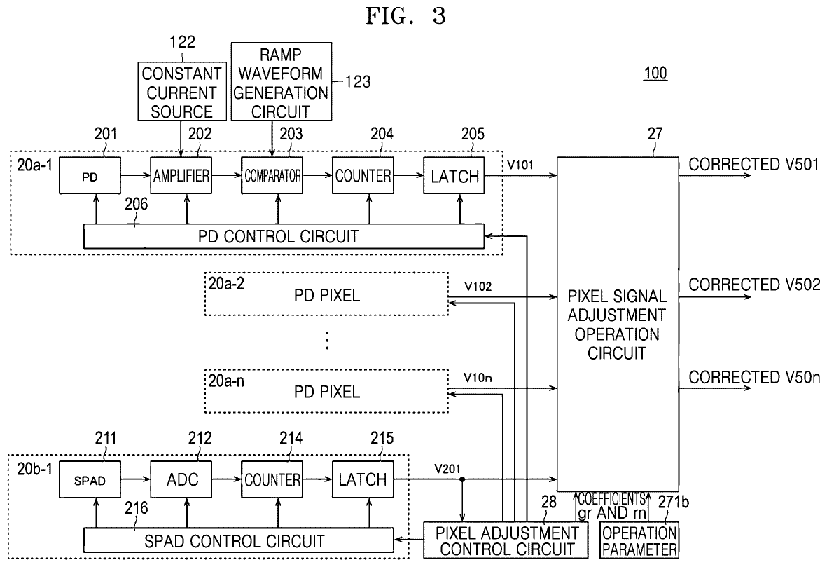

FIG. 3 is a block diagram illustrating the imaging device 100 according to an embodiment.

Each of pixels 20a-1 to 20a-n may include a PD 201, an amplifier 202, a comparator 203, a counter 204, a latch 205, and a PD control circuit 206. The PD 201 may correspond to a CMOS-type photoelectric conversion element. A constant current source 122 may be connected to the amplifier 202. A ramp waveform generation circuit 123 may be connected to the comparator 203. The ramp waveform generation circuit 123 may output a ramp signal, which constantly increases or decreases, for example, over a specific time period, under a certain condition (an initial value or a slope).

The comparator 203 may compare a ramp signal with a pixel signal and a reset signal, which are received from the amplifier 202, and the counter 204 may count the pixel signal and the reset signal until the pixel signal and the reset signal are inverted. Correlated double sampling may be performed based on a count value resulting from counting the pixel signal and the reset signal, and a count value corresponding to the difference between two measurements may be output as a digital signal. The latch 205 may preserve the digital signal. Under control by the PD control circuit 206, the latch 205 may output a preserved digital signal (e.g., V101) to a pixel signal adjustment operation circuit 27. The PD control circuit 206 may generate a control signal for each of the PD 201, the amplifier 202, the counter 204, the latch 205, the constant current source 122, and the ramp waveform generation circuit 123. Some of the functions of the PD control circuit 206 may be performed by the vertical scanning unit 130, the horizontal scanning unit 140, and the signal output unit 150 in FIG. 1.

A pixel 20b-1 may include a SPAD 211, an analog-to-digital converter (ADC) 212, a counter 214, a latch 215, and a SPAD control circuit 216. The SPAD 211 may include a SPAD-type photoelectric conversion element. For example, the ADC 212 may include an inverter. The ADC 212 may convert an output of the SPAD 211 into a pulse signal. The counter 214 and the latch 215 may have the same functions as the counter 204 and the latch 205. The counter 214 and the latch 215 may be respectively the same as or similar to the counter 204 and the latch 205. Under control by the SPAD control circuit 216, the latch 215 may output a preserved digital signal (e.g., V201) to the pixel signal adjustment operation circuit 27.

The SPAD control circuit 216 may generate a control signal for each of the function blocks (e.g., 211 to 215). The SPAD control circuit 216 may generate a control signal for each of the SPAD 211, the ADC 212, the counter 214, and the latch 215. Some of the functions of the SPAD control circuit 216 may be performed by the vertical scanning unit 130, the horizontal scanning unit 140, and the signal output unit 150 in FIG. 1.

The pixel signal adjustment operation circuit 27 may perform an operation on digital signals respectively output from the PD pixel 20a and the SPAD pixel 20b. The pixel signal adjustment operation circuit 27 may receive a digital signal from the PD pixel 20a and a digital signal from the SPAD pixel 20b. The pixel signal adjustment operation circuit 27 may perform an operation on the digital signals respectively from the PD pixel 20a and the SPAD pixel 20b.

For example, the pixel signal adjustment operation circuit 27 may perform a noise reduction operation on a pixel signal V101, based on the pixel signal V101 of the pixel 20a-1 and a pixel signal V201 of the SPAD pixel 20b-1 corresponding to the pixel 20a-1 and may thus output a corrected output signal V501 corresponding to the pixel signal V101. For example, the SPAD pixel 20b-1 corresponding to the pixel 20a-1 may be included in the pixel block 200 that includes the pixel 20a-1.

The pixel signal adjustment operation circuit 27 may receive the pixel signal V101 from the pixel 20a-1. The pixel signal adjustment operation circuit 27 may receive the pixel signal V201 from the SPAD pixel 20b-1 corresponding to the pixel 20a-1. The pixel signal adjustment operation circuit 27 may perform a noise reduction operation on the pixel signal V101, based on the pixel signal V101 and the pixel signal V201. The pixel signal adjustment operation circuit 27 may generate the corrected output signal V501.

The pixel signal adjustment operation circuit 27 may perform a noise reduction operation on a pixel signal V102, based on the pixel signal V102 of the pixel 20a-2 and the pixel signal V201 of the SPAD pixel 20b-1 corresponding to the pixel 20a-2 and may thus output a corrected output signal V502 corresponding to the pixel signal V102. The pixel signal adjustment operation circuit 27 may also perform a noise reduction operation on a pixel signal V10n, based on the pixel signal V10n of the pixel 20a-n and the pixel signal V201 of the SPAD pixel 20b-1 corresponding to the pixel 20a-n and may thus output a corrected output signal V50n corresponding to the pixel signal V10n.

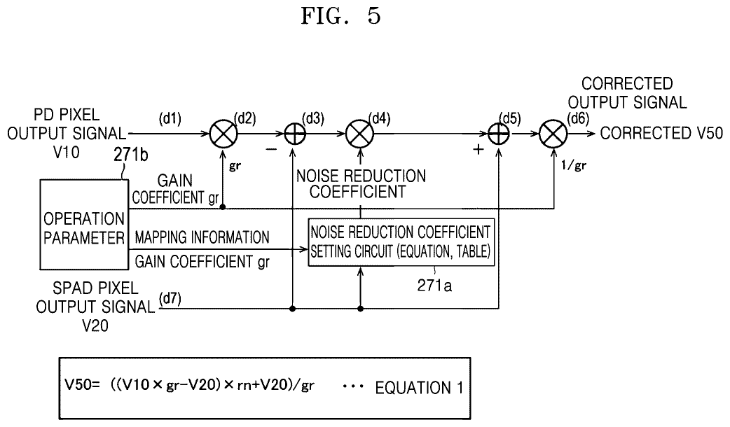

A pixel adjustment control circuit 28 may output a control signal to each of the PD control circuit 206, the SPAD control circuit 216, and the pixel signal adjustment operation circuit 27. The pixel signal adjustment operation circuit 27 may include a noise reduction coefficient setting circuit 271a (see FIG. 5 described below) and an operation parameter 271b. In an embodiment, the operation parameter 271b may be configured outside the pixel signal adjustment operation circuit 27 and may provide a gain coefficient gr and mapping information “m” to the pixel signal adjustment operation circuit 27. Functions of the pixel signal adjustment operation circuit 27 are described below.

As described above, the imaging device 100 may include the pixel array 120 and the pixel signal adjustment operation circuit 27. The pixel array 120 may include the PD pixel 20a including a first type photoelectric conversion element and the SPAD pixel 20b including a second type photoelectric conversion element. The pixel signal adjustment operation circuit 27 may generate a corrected output signal with respect to each PD pixel 20a by performing a noise reduction operation according to illuminance, based on an output signal of the PD pixel 20a and an output signal of the SPAD pixel 20b corresponding to the PD pixel 20a.

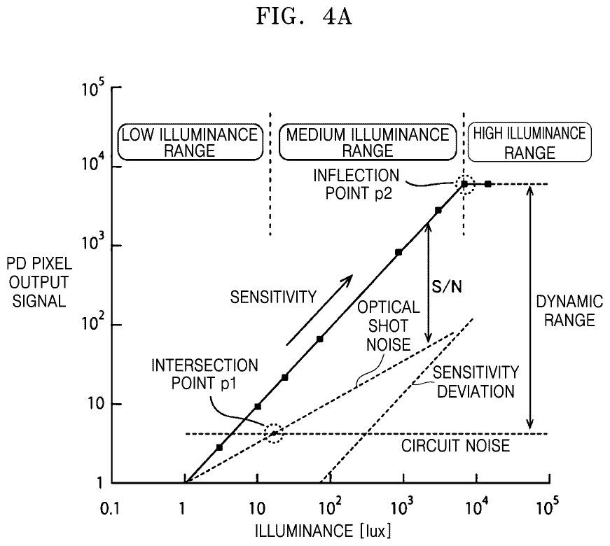

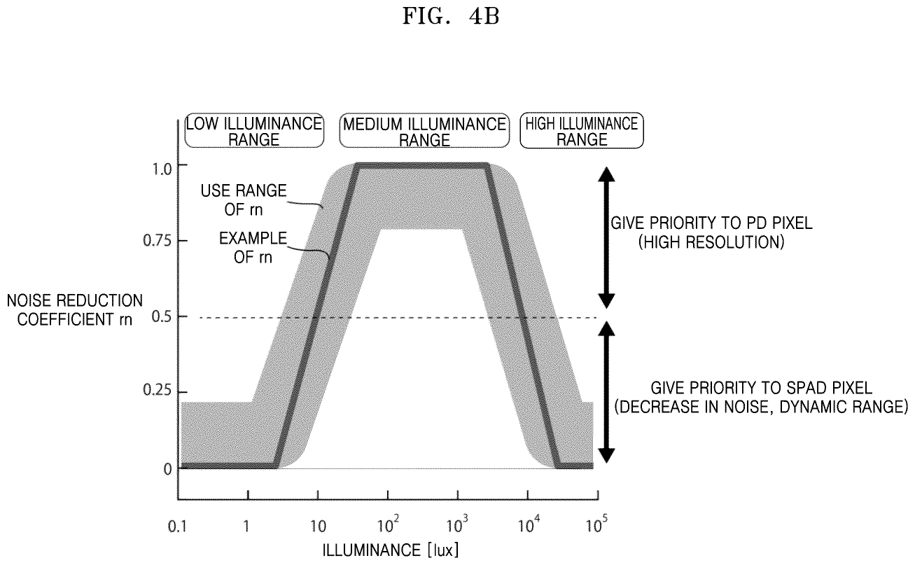

A noise reduction operation is described with reference to FIGS. 4A to 16. In the imaging device 100 according to an embodiment, the SPAD pixel 20b and the PD pixel 20a are arranged in a mixed manner in the pixel array 120. Before the noise reduction operation is described with reference to FIG. 4A, the characteristics of different types of photoelectric conversion elements are described.

FIG. 4A is a diagram illustrating output characteristics of a PD pixel, according to an embodiment.

In the imaging control of the PD pixel 20a, noise may be dominant at low illuminance, resulting in an image buried in noise. Noise may include circuit noise and optical shot noise. In particular, the circuit noise and the optical shot noise are highly influential at low illuminance. The circuit noise may include dark noise and read noise. Dark noise may occur even when there is no light. Dark noise may not depend on incident illuminance and may be almost constant. Read noise may be electronic noise that occurs in a signal reading process. Optical shot noise may occur because the arrival of photons is random according to the Poisson distribution. Sensitivity may be the size of a PD pixel output with respect to incident illuminance to the PD pixel 20a and has a slope of nearly a linear function indicating the relationship between the incident illuminance and a PD pixel output signal.

Within a high illuminance range, there may be charge saturation (limit) due to floating diffusion capacitance. An output may be saturated at an illuminance greater than the charge saturation.

An output signal of the PD pixel 20a may be dominated by noise at a certain low illuminance. In the present embodiment, illuminance that is lower than an intersection point p1 between the optical shot noise and the circuit noise (e.g., dark noise) may be referred to as a low illuminance range. A range greater than an inflection point p2, at which saturation occurs, may be referred to as a high illuminance range. The range between the low illuminance range and the high illuminance range may be referred to as a medium illuminance range. The intersection point p1 and the inflection point p2, which define the low illuminance range, the medium illuminance range, and the high illuminance range, may vary with the characteristics of the PD pixel 20a. For example, the intersection point p1 may be in the range of an illuminance of about 10 lux to about 102 lux. Therefore, a certain low illuminance may range from an illuminance of 0 to a value within a range of about 10 lux to about 102 lux. For example, the inflection point p2 may be within a range of about 103 lux to about 104 lux. A certain high illuminance may range from a value within the range of about 103 lux to about 104 lux and above. A certain medium illuminance may be in the medium range between low illuminance and high illuminance.

To summarize, a PD pixel and a SPAD pixel may have the following advantages and disadvantages. The PD pixel may be dominated by noise, such as dark noise, read noise, or optical shot noise, in the low illuminance range, resulting in an image buried by noise. In addition, the PD pixel may not increase a dynamic range in the high illuminance range because of charge saturation (limit) due to floating diffusion capacitance. On the other hand, the PD pixel may realize high resolution by allowing the sizes of circuits including a control circuit to decrease.

The SPAD pixel may have the following advantages and disadvantages. Because an electric pulse signal may be output by amplification like an avalanche when one photon is incident to the SPAD pixel, technology (referred to as a photon counting sensor (PCS)) for obtaining illuminance by counting electric pulse signals may be used so that low noise may be achieved at low illuminance and a high dynamic range may be implemented by sufficiently expanding the number of bits of a counter circuit. On the other hand, high resolution may not be realized because a circuit size required for count control is large. In addition, because power consumption also increases according to individual count control for each pixel, there is a problem in that it may be difficult to be used in a mobile application that is powered by a battery.

According to aspects of the present embodiments, these issues are addressed through cooperative control that takes advantages of pixel characteristics by mixing the PD pixel with the SPAD pixel. The details will be described below, but the outline is as follows.

FIG. 4B is a diagram illustrating the range of use of a noise reduction coefficient in low to high illuminance, according to an embodiment.

A noise reduction coefficient rn is described below (FIG. 5, etc.). In the low illuminance region, SPAD pixel information is preferentially processed. For example, when illuminance is less than a first threshold value, the pixel signal adjustment operation circuit 27 may generate a corrected output signal of the PD pixel 20a by using the output signal of the SPAD pixel 20b at a higher rate than the output signal of the PD pixel 20a. Specifically, as shown in FIG. 4B, the output signal of a SPAD pixel may be used at a higher rate than the output signal of a PD pixel by using the noise reduction coefficient rn less than 0.5. For example, in an ultralow illuminance region, a captured image may be formed using only SPAD pixel information without using PD pixel information. As a result, image information having low resolution but a high signal-to-noise ratio (SNR) may be obtained. As discussed herein, using a first pixel output signal at a higher rate than a second pixel output signal refers to giving more weight to the first pixel output signal when combining or using both signals to result in a corrected output signal. Further, as discussed in various embodiments herein, in certain illuminances, the ratio of usage (or relative weight) of a PD pixel to a corresponding SPAD pixel may be different from the ratio of usage (or relative weight) in other illuminances. For example, the ratio of usage of the SPAD pixel to the PD pixel may be higher for low illuminance, and may be relatively lower for medium illuminance.

In the medium illuminance region, information of both a PD pixel and a SPAD pixel may be adjusted and used according to illuminance. For example, when illuminance is at least the first threshold value but less than a second threshold value, the corrected output signal of the PD pixel 20a may be generated by using the output signal of the PD pixel 20a at a higher rate than the output signal of SPAD pixel 20b. Specifically, in the low to medium illuminance, as the illuminance increases, PD pixel information may be preferentially processed. Specifically, the output signal of a PD pixel may be used at a higher rate than the output signal of a SPAD pixel by using the noise reduction coefficient rn that exceeds 0.5. As a result, image information having high resolution may be obtained.

In the high illuminance region, which is close to charge saturation or in which a PD pixel is charge-saturated, SPAD pixel information may be preferentially treated. For example, when illuminance is at least the second threshold value, the corrected output signal of the PD pixel 20a may be generated by using the output signal of the SPAD pixel 20b at a higher rate than the output signal of the PD pixel 20a. Specifically, as shown in FIG. 4B, the output signal of a SPAD pixel may be used at a higher rate than the output signal of a PD pixel by using the noise reduction coefficient rn less than 0.5. As a result, a captured image having low resolution but a high dynamic range may be obtained.

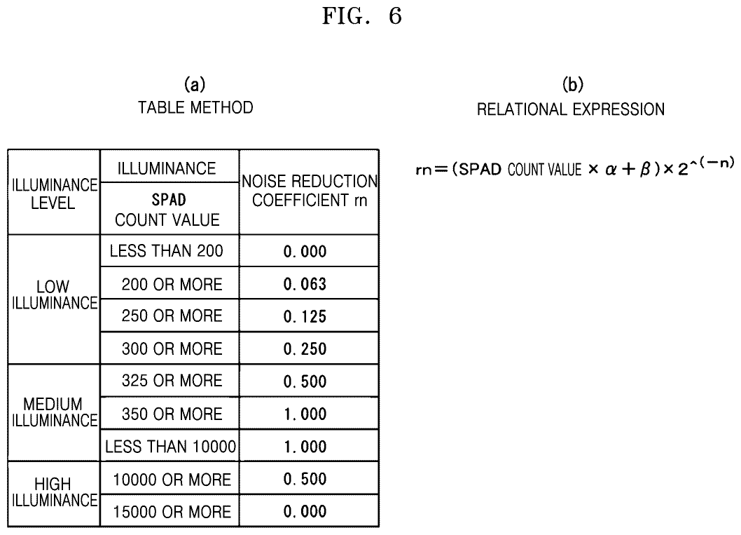

FIG. 5 is a diagram illustrating noise reduction operation processing according to an embodiment. FIG. 6 illustrates mapping information showing the relationship between illuminance of an operation parameter and a noise reduction coefficient, according to an embodiment.

In an embodiment, the pixel signal adjustment operation circuit 27 may include the noise reduction coefficient setting circuit 271a and the operation parameter 271b. The operation parameter 271b may provide the gain coefficient gr and mapping information. The noise reduction coefficient setting circuit 271a may receive a SPAD pixel output signal V20, the gain coefficient gr, and the mapping information. The noise reduction coefficient setting circuit 271a may determine (or calculate) the noise reduction coefficient rn, based on the SPAD pixel output signal V20, the gain coefficient gr, and the mapping information. The noise reduction coefficient setting circuit 271a may provide the noise reduction coefficient rn. The pixel signal adjustment operation circuit 27 may generate a corrected output signal V50, based on a PD pixel output signal V10, the SPAD pixel output signal V20, the gain coefficient gr, and the noise reduction coefficient rn. The pixel signal adjustment operation circuit 27 may output the corrected output signal V50.

For example, when illuminance is equal to or less than a first value, the noise reduction coefficient rn may have a fifth value. When illuminance has at least a third value, the noise reduction coefficient rn may have the fifth value. When illuminance has a second value, the noise reduction coefficient rn may have a sixth value. When illuminance exceeds the first value and is less than the second value, the noise reduction coefficient rn may exceed the fifth value and be less than the sixth value. As illuminance increases from the first value to the second value, the noise reduction coefficient rn may increase. When illuminance exceeds the second value and is less than the third value, the noise reduction coefficient rn may exceed the fifth value and be less than the sixth value. As illuminance increases from the second value to the third value, the noise reduction coefficient rn may decrease. Here, the second value of the illuminance may be greater than the first value of the illuminance, and the third value of the illuminance may be greater than the second value of the illuminance. The sixth value of the noise reduction coefficient may be greater than the fifth value of the noise reduction coefficient.

The operation parameter 271b may include the gain coefficient gr and mapping information. The gain coefficient gr may be used to add the scales (sensitivities) of output signals between the PD pixel 20a and the SPAD pixel 20b and may be determined by the characteristics (aperture ratio, material, lens shape, wavelength dependence, and temperature characteristic) of each type of photoelectric conversion element. The mapping information may describe the relationship between illuminance and the noise reduction coefficient rn. For the mapping information, there may be a table method shown in (a) of FIG. 6 and a relational expression method shown in (b) of FIG. 6, and both the table and equation method may be used. In the present embodiment, the output value (e.g., count value) of the SPAD pixel 20b may be used as an illuminance value. The noise reduction coefficient rn may take a value within a range of 0 to 1. When the noise reduction coefficient rn is set to a negative multiplier of 2, such as 1, 0.5, 0.25, 0.125, or 0.0625, in the table method shown in (a) of FIG. 6, the pixel signal adjustment operation circuit 27 may perform a noise reduction operation using a bit shift operation. In the embodiments of FIGS. 2B and 3, the count value of one SPAD pixel 20b in the pixel block 200 may be used.

The operation parameter 271b including the gain coefficient gr and mapping information may be freely set through register setting by a user through an external interface. In this case, the operation parameter 271b may be set in terms of subcategories according to the factors of illuminance, temperature, and a filter (R, G, or B). A table and an equation respectively shown in (a) and (b) of FIG. 6 are just examples, and a count value (or illuminance) and a coefficient may be appropriately set. For example, the relational expression in (b) of FIG. 6 is a first-order equation, but a second-order equation, an N-th-order equation, or a function using a root may be used.

The pixel signal adjustment operation circuit 27 may generate the corrected output signal V50 after correction using Equation 1.

As shown in FIG. 5 and Equation 1, the pixel signal adjustment operation circuit 27 may first multiply the PD pixel output signal V10 by the gain coefficient gr.

Subsequently, the pixel signal adjustment operation circuit 27 may subtract the SPAD pixel output signal V20 from a result of the multiplication and then multiply a result of the subtraction by the noise reduction coefficient rn. The noise reduction coefficient rn may be set according to illuminance (e.g., a SPAD count value), as shown in the mapping information in (a) and (b) of FIG. 6. Thereafter, the SPAD pixel output signal V20 may be added to a result of the multiplication so that the corrected output signal V50 after correction may be obtained.

$$V 50 = ( ( V 10 \times gr - V 20 ) \times rn + V 20 ) / gr \qquad [ Equation 1 ]$$

As described above, the pixel signal adjustment operation circuit 27 may calculate a corrected output signal of the PD pixel 20a, based on the noise reduction coefficient rn, by using Equation 1. The noise reduction coefficient rn may be set to be lowest at low illuminance and at high illuminance and highest at medium illuminance between the low illuminance and the high illuminance and set to gradually increase as illuminance increases from the low illuminance to the high illuminance and gradually decrease as illuminance increases from the medium illuminance to the high illuminance.

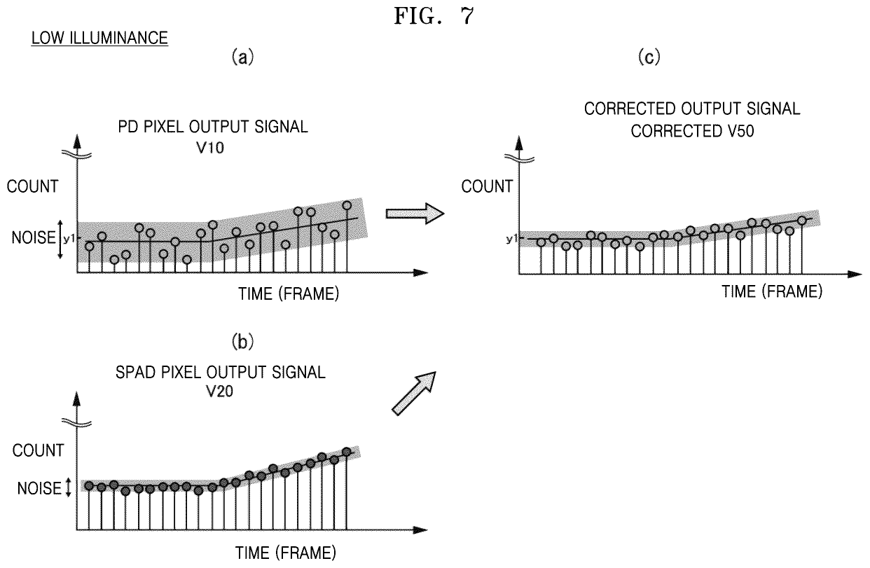

FIG. 7 is a diagram illustrating the relationship between an output signal of a pixel and a noise reduction operation in a low-illuminance imaging environment, according to an embodiment.

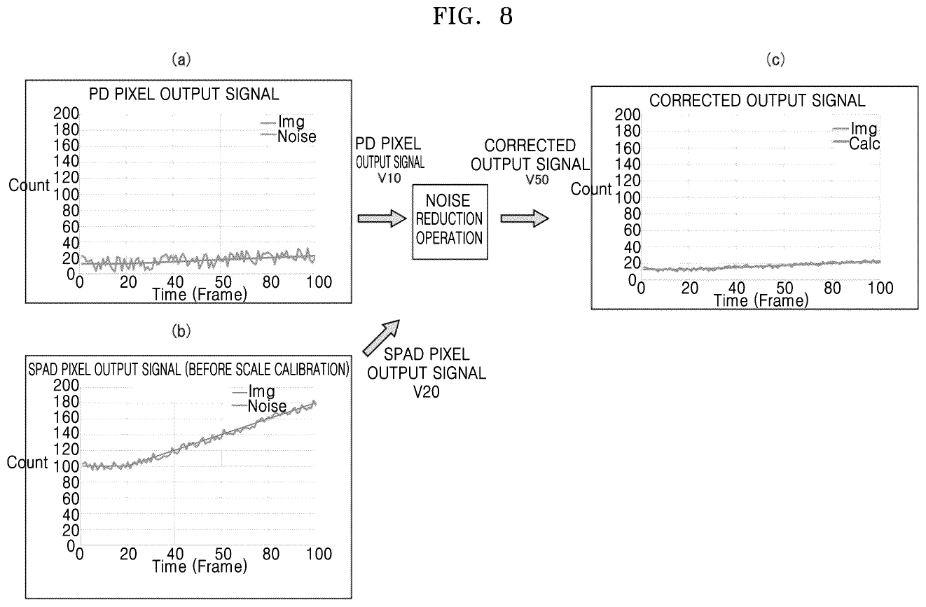

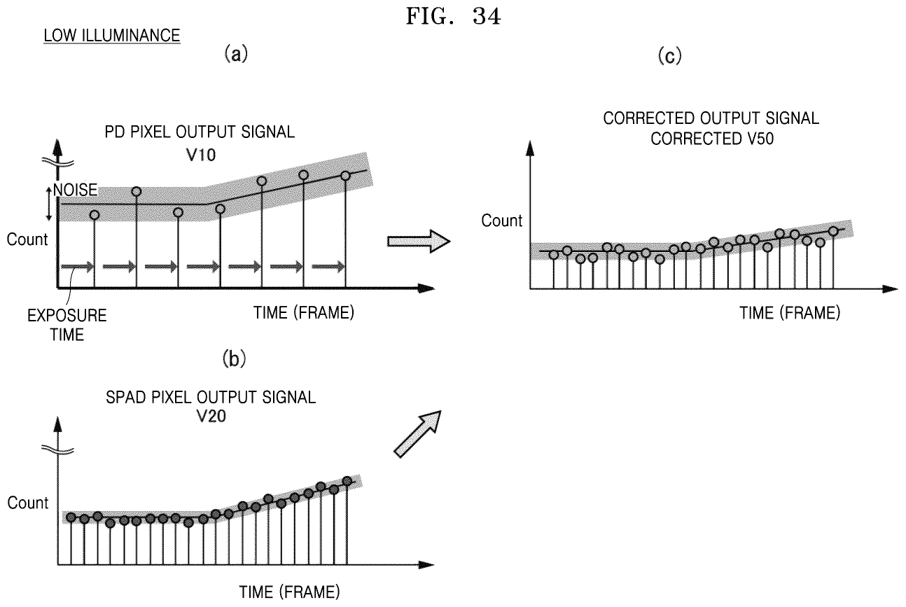

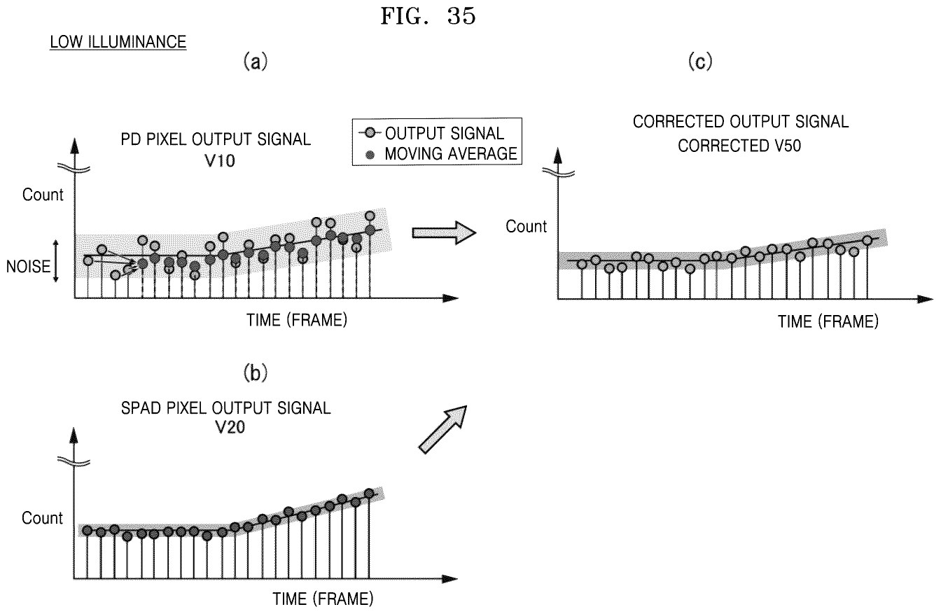

The horizontal axis (or the x axis) is time, and the vertical axis (or the y axis) is the output signal (or the illuminance count) of the PD pixel 20a or the SPAD pixel 20b. The scale of the output signal of the PD pixel 20a on the vertical axis matches that of the SPAD pixel 20b on the vertical axis (i.e., scale adjustment using the gain coefficient gr) in FIG. 7 (the same is also applied to FIGS. 34 and 35). FIG. 7 shows an example in which the amount of incident light gradually increases over time in the latter half. The output signal of the PD pixel 20a is shown in (a) of FIG. 7, and the output signal of the SPAD pixel 20b at the same timing of the amount of incident light as that in (a) of FIG. 7 in the pixel block 200 including the PD pixel 20a is shown in (b) of FIG. 7 (the same is applied to FIG. 8 below).

As shown in (a) of FIG. 7, at low illuminance, a PD pixel output signal may have large noise and thus be buried in noise. As shown in (b) of FIG. 7, even in the same low illuminance, a SPAD pixel output signal may have small noise and thus lead a high SNR. A corrected output signal obtained by a noise reduction operation using Equation 1 in FIG. 5 is shown in (c) of FIG. 7. It may be seen in (c) of FIG. 7 that the absolute value of the corrected output signal V50 obtained after correction is maintained while variability (e.g., noise) is reduced, compared to the PD pixel output signal V10 before the correction.

FIG. 8 is a diagram illustrating specific examples of output signals in a low-illuminance imaging environment, according to an embodiment.

FIG. 8 shows the development of an output signal in a situation in which the amount of incident light is small up to a 20th frame and brightness gradually increases after the 20th frame. As shown in (a) of FIG. 8, at low illuminance, a PD pixel output signal may have large noise and thus be buried in noise. As shown in (b) of FIG. 8, even in the same low illuminance, a SPAD pixel output signal may have small noise and thus lead a high SNR. The SPAD pixel output signal shown in (b) of FIG. 8 may be before scale calibration. The scale (sensitivity) of the PD pixel output signal may be matched with the scale (sensitivity) of the SPAD pixel output signal by multiplying the PD pixel output signal by the gain coefficient gr (see FIG. 5). A corrected output signal obtained by a noise reduction operation using Equation 1 in FIG. 5 is shown in (c) of FIG. 8. It may be seen in (c) of FIG. 8 that the absolute value of the corrected output signal V50 obtained after correction is maintained while variability (e.g., noise) is reduced, compared to the PD pixel output signal V10 before the correction.

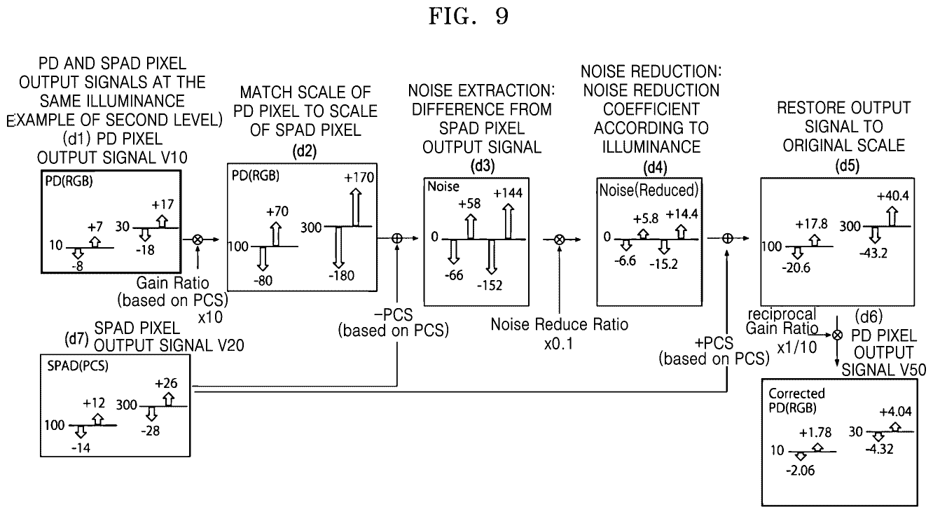

FIG. 9 is a diagram illustrating a noise reduction operation in a low-illuminance imaging environment, according to an embodiment.

Output signals of pixels at two levels of light irradiation are shown in (d1) to (d7) in FIG. 9. (d1) to (d7) in FIG. 9 respectively correspond to (d1) to (d7) in FIG. 5. In FIG. 9, (d1) shows a PD pixel output signal and (d7) shows a SPAD pixel output signal.

In the PD pixel output signal in (d1) in FIG. 9, noise, such as shot noise or circuit noise, may be large. In (d1), output signal values respectively corresponding to two levels of light irradiation may be respectively “10” and “30”. Noise may have values of −8, +7, −18, and +17, which are substantially the same sizes as the output signals. In the PD pixel output signal in (d1), circuit noise is dominant. In (d7) showing the SPAD pixel output signal, output signal values respectively corresponding to two levels of light irradiation may be respectively “100” and “300”. Noise may have values of −14, +12, −28, and +26, which are sufficiently smaller than the output signals. Shot noise is dominant in the noise of the SPAD pixel output signal in (d7).

(d2) is an output signal obtained by multiplying (d1) by the gain coefficient gr, which may be a gain ratio. The gain coefficient gr may be changed by register setting, as described above. (d3) is an output signal obtained by subtracting (d7) from (d2). In (d3), only a noise component may remain (at low illuminance) or a signal component may be included in a noise component (in low to medium illuminance).

(d4) is obtained by multiplying (d3) by the noise reduction coefficient rn. The noise reduction coefficient rn may be set according to illuminance (see FIG. 6). In FIG. 9, for clear understanding, “0.1” is used as the noise reduction coefficient rn. When illuminance is low, the noise reduction coefficient rn may be set small. For example, although “0.1” is used as the noise reduction coefficient rn in FIG. 9, the noise reduction coefficient rn may be set to “0” when the illuminance (count value) of a SPAD pixel is 200 or less, as shown in (a) in FIG. 6, and may be set to “0.25” when the illuminance of the SPAD pixel is 300 or more.

Subsequently, (d5) is obtained by adding (d7) to (d4). Noise (e.g., −14, +12, etc.) of (d7) may be included in (d5).

(d6) represents a final output signal, i.e., the corrected output signal V50, which is obtained by multiplying 1/gr by (d5). Although (d5) is multiplied by 1/gr in the last stage to match the final output signal to a PD output oscillation, this last stage may be omitted when the scale is matched to a SPAD signal. Compared to the initial PD pixel output signal V10 in (d1) before correction, it can be seen that the absolute value of a signal is maintained while variability (noise) is reduced in the final corrected output signal V50.

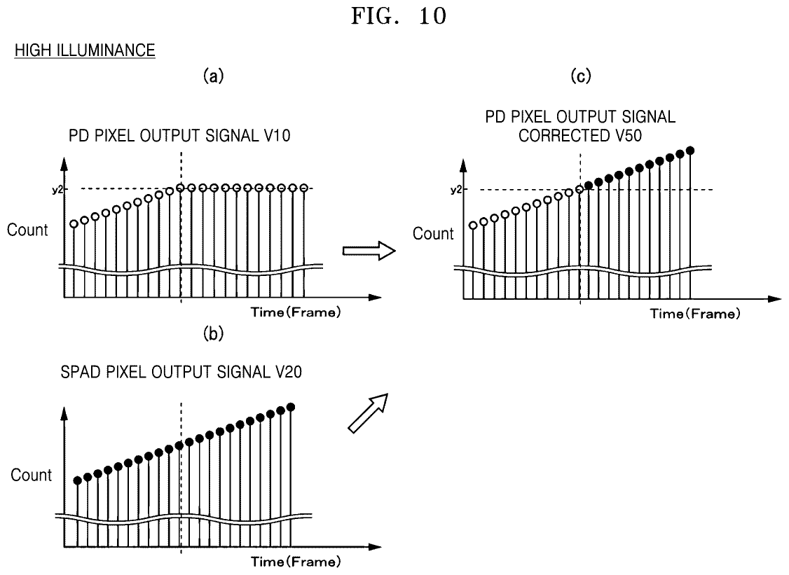

FIG. 10 is a diagram illustrating the relationship between an output signal of a pixel and a noise reduction operation in a high-illuminance imaging environment, according to an embodiment.

As shown (a) of FIG. 10, at high illuminance, a PD pixel output signal may saturate at a count y2. The count y2 may correspond to the inflection point p2 in FIG. 4A. As shown in (b) of FIG. 10, even at the same high illuminance, a SPAD pixel output signal may be continuously counted without saturation when the bit width of a count circuit is sufficient. A corrected output signal obtained by a noise reduction operation using Equation 1 in FIG. 5 is shown in (c) of FIG. 10. As shown in (c) of FIG. 10, illuminance information may be obtained without saturation even at the high illuminance (at least the count y2) with respect to the corrected output signal V50 after correction compared to the PD pixel output signal V10 before the correction.

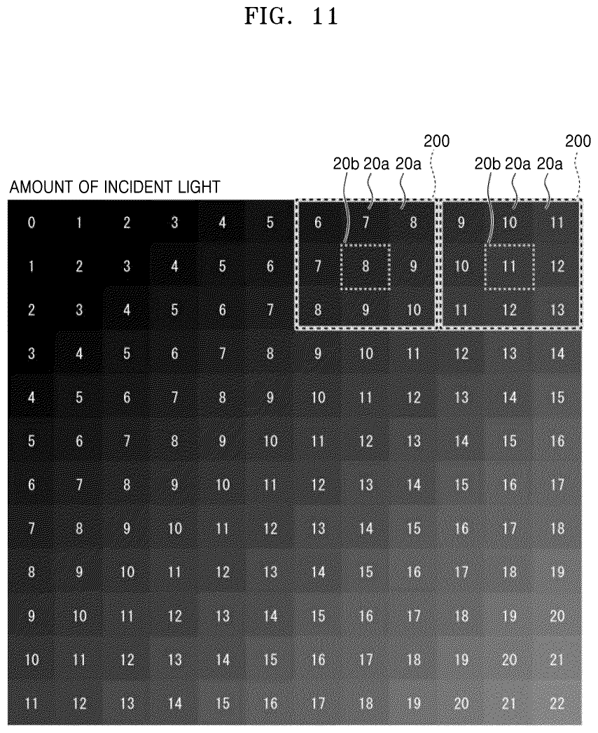

FIGS. 11 to 16 are diagrams illustrating specific examples of noise reduction operations according to embodiments.

FIGS. 11 to 16 show specific examples of noise reduction operations when low-illuminance light is incident to the pixel array 120. FIGS. 11 to 16 each show an output signal of each pixel 20 of the pixel array 120 including 12×12 pixels 20.

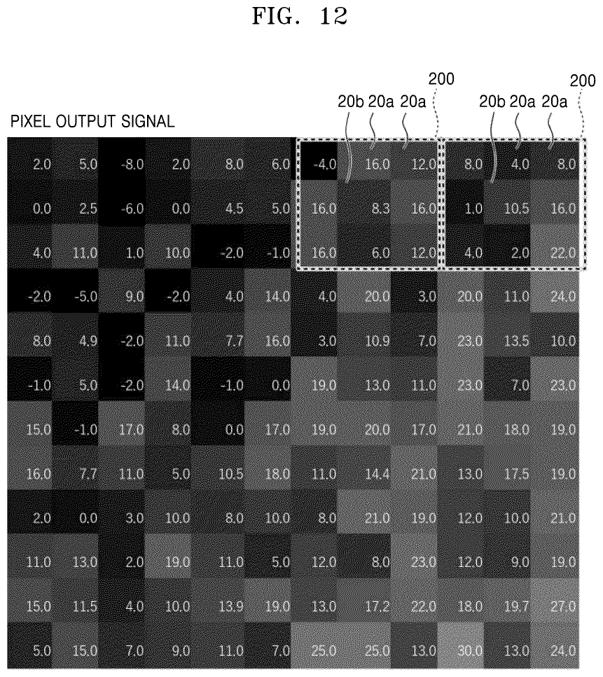

In the same manner as shown in FIGS. 2A and 2B, the pixel block 200 may include 3×3 pixels, and a SPAD pixel 20b is at the center of the pixel block 200 and eight PD pixels 20a may be arranged around the SPAD pixel 20b in the pixel block 200. In FIGS. 11 and 12, only some PD pixels, some SPAD pixels, and some pixel blocks are respectively marked with reference numerals 20a, 20b, and 200. The numbers in FIGS. 11 to 16 are scaled to the output signals of the PD pixels 20a. For example, in FIG. 12, when there is a difference of 10 times in scale between the output signal of the SPAD pixel 20b and the output signal of the PD pixel 20a with respect to the same illuminance value, a value obtained by adjusting the scale by reducing the output signal (illuminance information value) of the SPAD pixel 20b to 1/10 may be shown.

FIG. 11 shows the amounts of incident light. FIG. 12 shows pixel output signals according to the amounts of incident light in FIG. 11. Although noise components are added in FIG. 12, the SPAD pixel 20b has small noise and the PD pixel 20a has large noise.

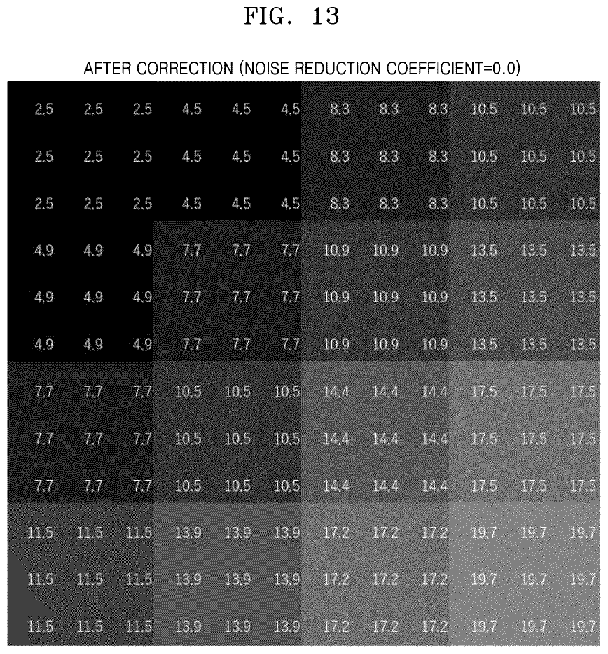

FIGS. 13 to 16 show the corrected output signal V50 of each pixel 20 when the level of the noise reduction coefficient rn is changed. With respect to the SPAD pixel 20b at the center of each pixel block 200, the SPAD pixel output signal V20 is output as is.

FIG. 13 illustrates the corrected output signal V50 when the noise reduction coefficient rn is 0. In this case, the output signal of the PD pixel 20a may not be used, and the output signal of the SPAD pixel 20b at the center of the pixel block 200 may replace the output signal of each PD pixel 20a included in the pixel block 200. For example, corrected output signals V50 corresponding to the pixels of the pixel block 200 may all have the same value as the output signal of the SPAD pixel 20b. In this case, the noise component of the output signal may be small, but resolution (e.g., dots per inch (dpi) may be decreased to 1/3 of the full resolution using all pixels.

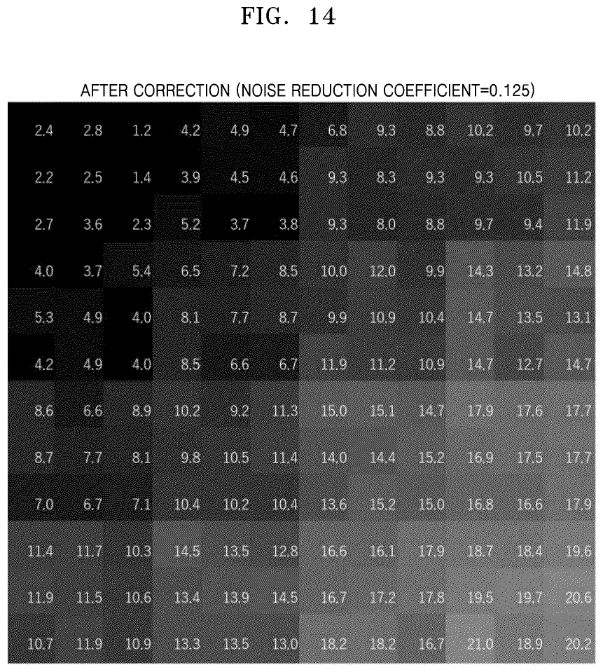

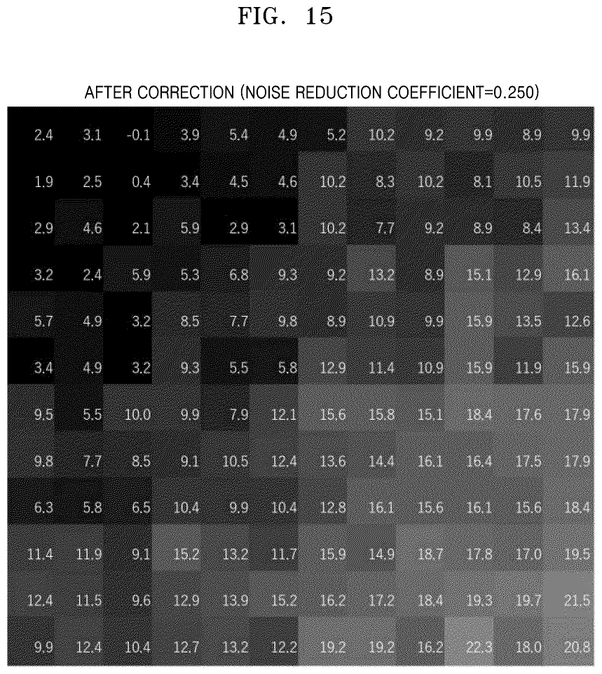

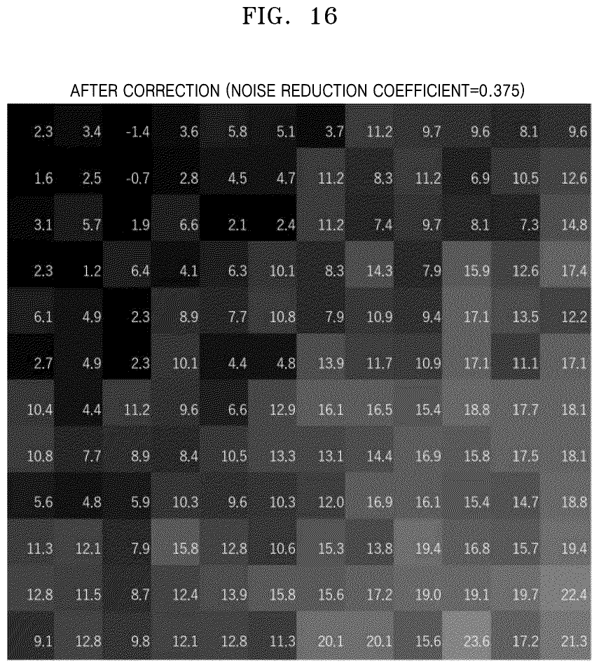

FIG. 14 illustrates the corrected output signal V50 when the noise reduction coefficient rn is 0.125. FIG. 15 illustrates the corrected output signal V50 when the noise reduction coefficient rn is 0.25. FIG. 16 illustrates the corrected output signal V50 when the noise reduction coefficient rn is 0.375. As the noise reduction coefficient rn increases, resolution may gradually increase though the noise component of an output signal increases.

In the examples of the noise reduction coefficient rn in FIGS. 13 to 16, the noise reduction coefficient rn is uniformly used (as a certain low-illuminance range) for all pixel blocks 200 regardless of illuminance at the location of each pixel block 200. However, as a more suitable example, a different noise reduction coefficient rn may be used for each pixel block 200 according to the illuminance of the pixel block 200. When a different noise reduction coefficient rn is used for each pixel block 200, effective noise reduction may be realized while high resolution and high contrast are maintained so that an image close to the ideal image (without noise) of FIG. 11 may be obtained.

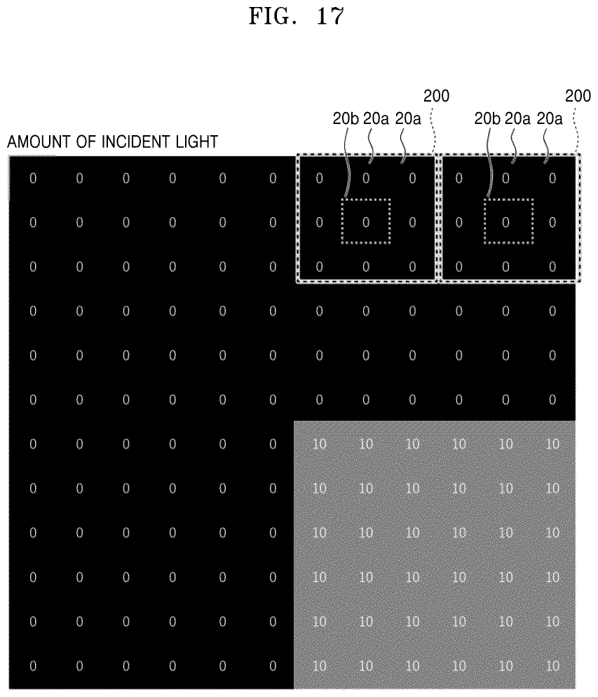

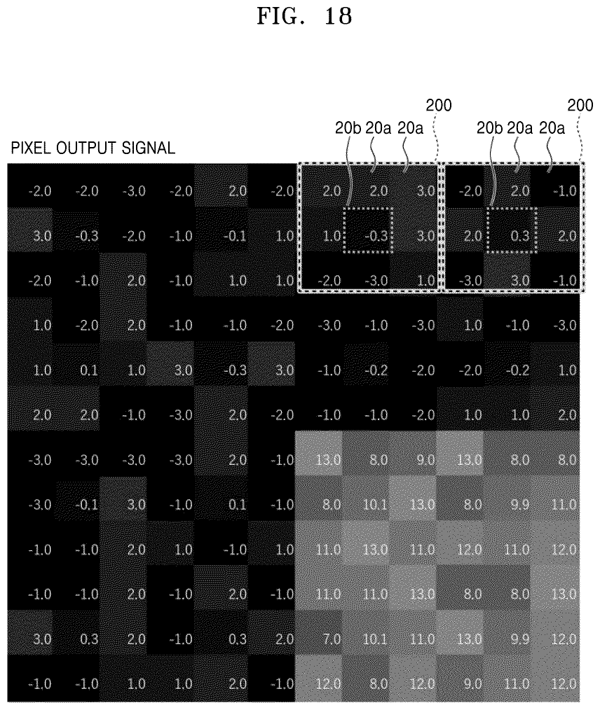

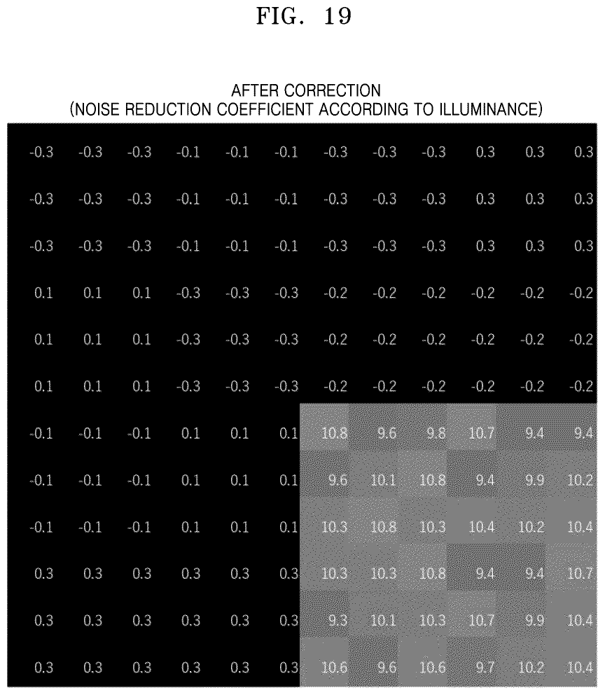

Examples of the form of this image are illustrated in FIGS. 17 to 19. FIG. 17 shows the amount of incident light. In the example of FIG. 17, the amount of incident light in a lower right quarter region is greater than in the other region. FIG. 18 illustrates pixel output signals according to the amount of incident light in FIG. 17. Although noise components are added in FIG. 18, the SPAD pixel 20b has small noise and the PD pixel 20a has large noise. FIG. 19 illustrates the corrected output signal V50 obtained by applying a noise reduction coefficient according to illuminance in the relational expression in (b) of FIG. 6. Here, a different noise reduction coefficient rn may be used according to the count value of each SPAD pixel, i.e., the illuminance of each pixel block, by using a linear expression, in which α is 0.025, β is 0, and n is 0 in the relational expression in (b) of FIG. 6, wherein rn is within a range of 0 to 1. According to the present embodiment, both high resolution and high contrast may be achieved while noise in an ultra-low illuminance region is reliably suppressed, as shown in FIGS. 18 and 19.

As described above, the imaging device 100 of FIG. 1 may include a pixel array, which includes a PD pixel and a SPAD pixel, and a pixel signal adjustment operation circuit, which generates a corrected output signal of each PD pixel by performing a noise reduction operation according to illuminance, based on an output signal of the PD pixel and an output signal of the SPAD pixel corresponding to the PD pixel. By including such a configuration, satisfactory image quality characteristics may be obtained in imaging under shooting conditions ranging from low illuminance to high illuminance.

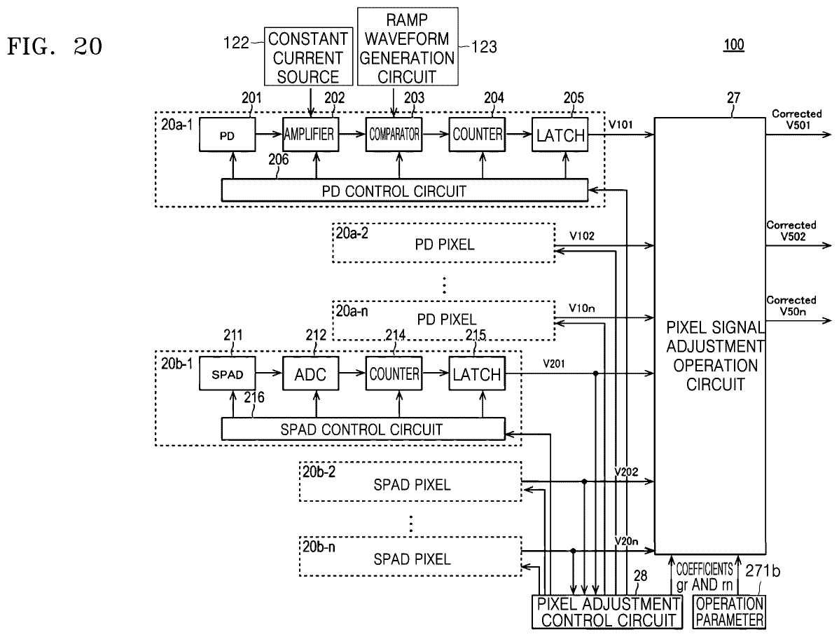

The imaging device 100 according to an embodiment is described below with reference to FIGS. 20 and 21. In the embodiment of FIG. 1, the PD pixel 20a to be corrected may correspond to one SPAD pixel 20b in the pixel block 200 including the PD pixel 20a, and a noise reduction operation may be performed on the PD pixel 20a by using an output signal of the SPAD pixel 20b. Contrarily, in the embodiment of FIG. 20 or 21, the PD pixel 20a to be corrected may correspond to a plurality of SPAD pixels 20b around the PD pixel 20a, and an integrated output signal may be generated by integrating output signals of the SPAD pixels 20b. Noise reduction may be performed on the PD pixel 20a by using the integrated output signal.

FIG. 20 is a block diagram illustrating an imaging device according to an embodiment. FIG. 21 is a diagram illustrating an integrated output signal generated using a distance ratio, according to an embodiment.

FIG. 20 may correspond to FIG. 3. As shown in FIG. 20, in an embodiment, each of PD pixels 20a-1 to 20a-n may be corrected using an integrated output signal obtained by integrating output signals of a plurality of SPAD pixels 20b-1 to 20b-n.

FIG. 21 shows a portion extracted from a pixel array 120x. The arrangement of PD pixels 20a and SPAD pixels 20b of the pixel array 120x is similar to that in FIG. 2A, but the arrangement of color filters is different from that in FIG. 2A. The pixel signal adjustment operation circuit 27 may generate an integrated output signal, which is obtained by integrating output signals of a plurality of SPAD pixels by using a distance ratio, based on position information of a PD pixel to be corrected and position information of each of a plurality of PD pixels.

The upper part of FIG. 21 shows the signal of one pixel block (of R color) surrounded by a rectangular dashed line in the pixel array 120x. For example, as shown in FIG. 21, an integrated output signal d11 used for correction of a PD pixel 20a-11 may be obtained by integrating output signals of four SPAD pixels 20b-1 to 20b-4 adjacent to the PD pixel 20a-11 in all directions, based on a distance ratio. For example, “6” may be obtained as the integrated output signal d11 for the PD pixel 20a-11 by performing linear interpolation (e.g., dual linear interpolation) in two directions, e.g., the horizontal and vertical directions, using output signals, “2,” “5,” “5,” and “8”, of four adjacent SPAD pixels 20b. An integrated output signal for a PD pixel 20a at an edge where linear interpolation is impossible may be calculated by directly using an output signal of one adjacent SPAD pixel 20b or by performing extrapolation as shown in FIG. 21.

Thereafter, the pixel signal adjustment operation circuit 27 may generate a corrected output signal of each PD pixel 20a by using an integrated output signal at a position corresponding to a PD pixel 20a to be corrected, through the same processing as in the embodiment of FIG. 1. In this way, the imaging device 100 of the embodiment of FIG. 20 may generate a corrected output signal of each PD pixel by performing a noise reduction operation according to illuminance, based on an output signal of a target PD pixel and an integrated output signal. Accordingly, satisfactory image quality characteristics may be obtained under shooting conditions ranging from low illuminance to high illuminance in imaging.

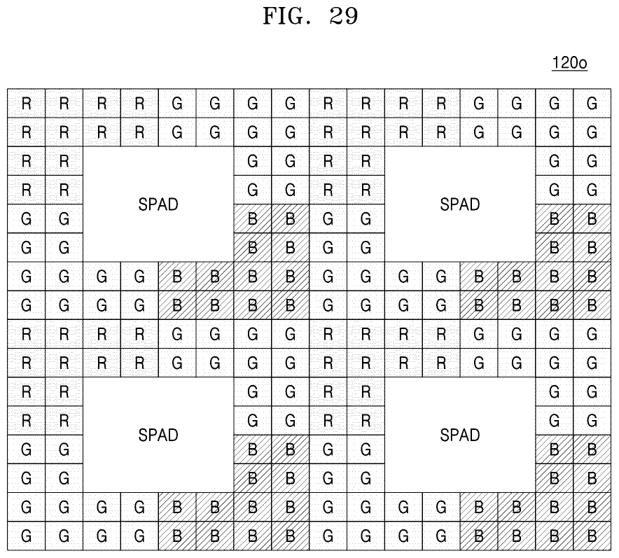

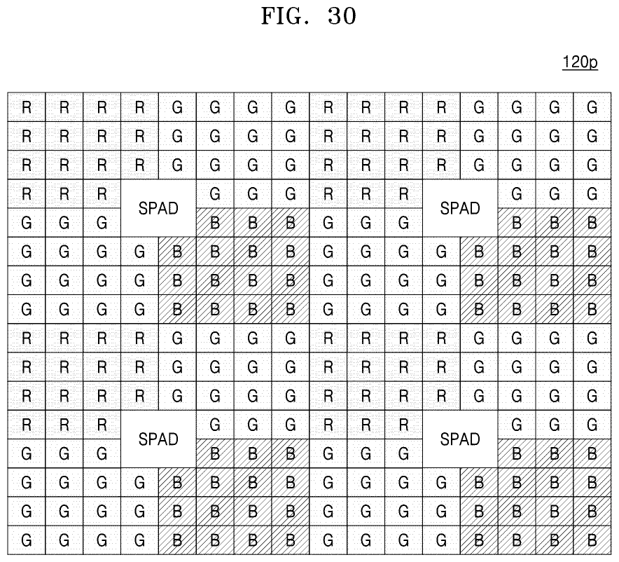

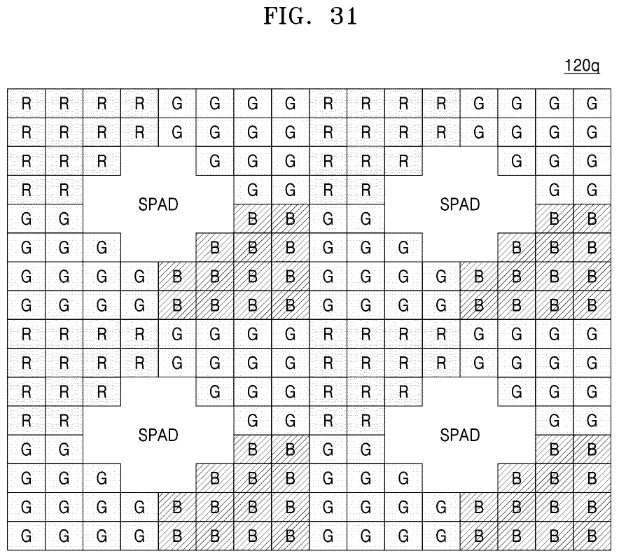

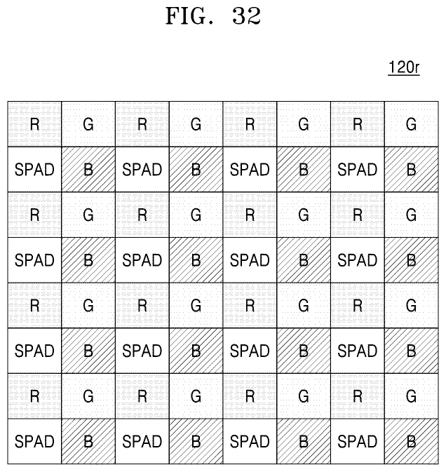

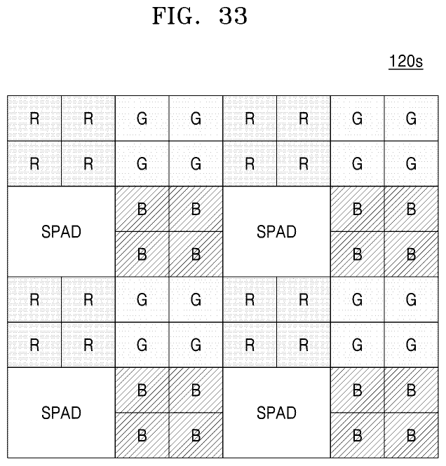

FIGS. 22 to 33 are diagrams illustrating examples of the pixel array 120 of the imaging device 100, according to embodiments.

These examples may be applied to the imaging device 100 of FIG. 1 and the imaging device 100 of FIG. 2. A configuration other than a pixel array may be the same as the configuration described with reference to FIG. 20, and thus, detailed descriptions thereof are omitted. In the pixel array 120 described above and respective pixel arrays 120a to 120s of FIGS. 22 to 33, SPAD pixels 20b may be arranged at equal intervals throughout each of the pixel arrays 120a to 120s to be adjacent to PD pixels 20a.

In the pixel arrays 120a to 120e respectively shown in FIGS. 22 to 26, a notation is the same as that in the legend in FIG. 22. In the respective pixel arrays 120a to 120c of FIGS. 22 to 25, a SPAD pixel 20b may have a large size that is four (e.g., 2×2) times the size of a PD pixel 20a. Referring to FIG. 22, a pixel block may include one SPAD pixel 20b and a plurality of PD pixels 20a. The SPAD pixel 20b may be at the center of the pixel block, and the PD pixels 20a may surround the SPAD pixel 20b. The PD pixels 20a included in the pixel block may correspond to the same color filter. For example, the pixel array 120a may include pixel blocks in four rows and four columns. A pixel block in a first row and a first column may include PD pixels 20a corresponding to R pixels, a pixel block in the first row and a second column may include PD pixels 20a corresponding to G pixels, a pixel block in a second row and the first column may include PD pixels 20a corresponding to G pixels, and a pixel block in the second row and the second column may include PD pixels 20a corresponding to B pixels.

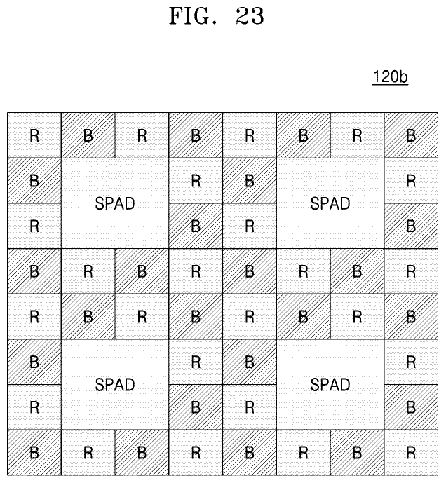

Referring to FIG. 23, a pixel block may include one SPAD pixel 20b and a plurality of PD pixels 20a. The SPAD pixel 20b may be at the center of the pixel block, and the PD pixels 20a may surround the SPAD pixel 20b. Unlike FIG. 22, the pixel block in FIG. 23 may include PD pixels 20a having different color filters. For example, the pixel block may include a PD pixel 20a corresponding to an R pixel and a PD pixel 20a corresponding to a B pixel. The PD pixel 20a corresponding to the R pixel may be adjacent to the PD pixel 20a corresponding to the B pixel in the pixel block.

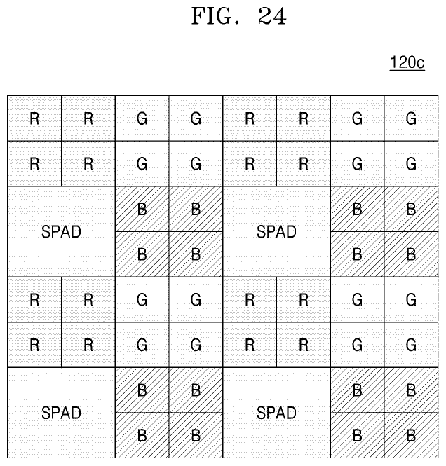

Referring to FIG. 24, a pixel block may include one SPAD pixel 20b and a plurality of PD pixels 20a. The SPAD pixel 20b may be located at the lower left of the pixel block. PD pixels 20a corresponding to R pixels may be at the upper left of the pixel block, PD pixels 20a corresponding to G pixels may be at the upper right of the pixel block, and PD pixels 20a corresponding to B pixels may be at the lower right of the pixel block.

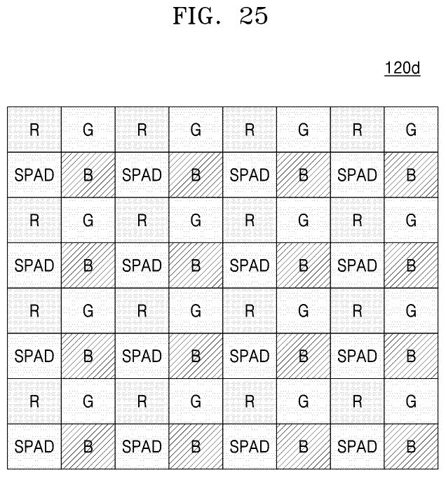

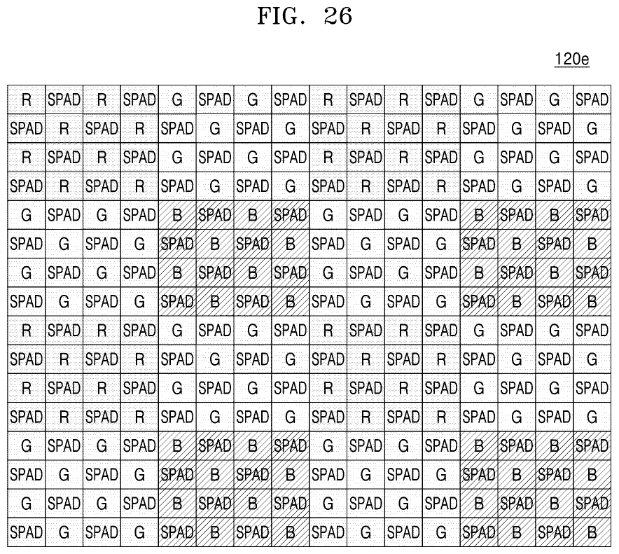

The pixel arrays 120d and 120e of FIGS. 25 and 26 are examples in which the arrangement ratio of SPAD pixels 20b is increased. Referring to FIG. 25, a pixel block may include one SPAD pixel 20b and a plurality of PD pixels 20a. The pixel block may be composed of two rows and two columns. The size of the SPAD pixel 20b may be the same as the size of each PD pixel 20a. In the pixel block, a PD pixel 20a corresponding to an R pixel may be in a first row and a first column, a PD pixel 20a corresponding to a G pixel may be in the first row and a second column, the SPAD pixel 20b may be in a second row and the second column, and a PD pixel 20a corresponding to a B pixel may be in the second row and second column.

Referring to FIG. 26, a SPAD pixel 20b and a PD pixel 20a having an R, G, or B color filter may be repeatedly arranged. In a pixel block, the SPAD pixel 20b may be adjacent to the PD pixel 20a. The pixel array 120c may include pixel blocks in four rows and four columns. For example, a pixel block in a first row and a first column may include a plurality of SPAD pixels 20b and PD pixels 20a corresponding to R pixels, a pixel block in the first row and a second column may include a plurality of SPAD pixels 20b and PD pixels 20a corresponding to G pixels, a pixel block in a second row and the first column may include a plurality of SPAD pixels 20b and PD pixels 20a corresponding to G pixels, and a pixel block in the second row and the second column may include a plurality of SPAD pixels 20b and PD pixels 20a corresponding to B pixels.

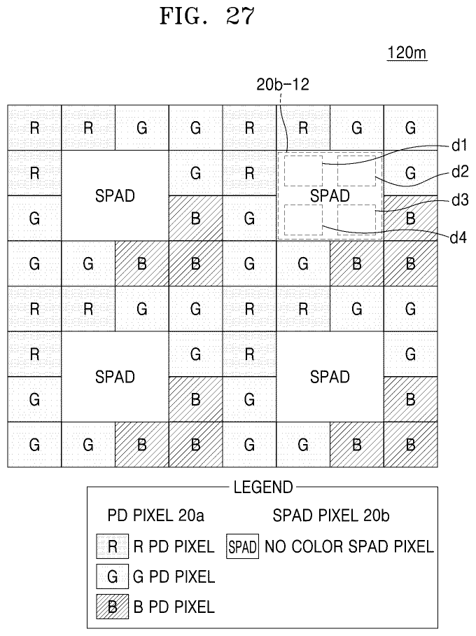

FIGS. 27 to 33 are diagrams illustrating examples of the pixel array 120 of the imaging device 100. In the pixel arrays 120m to 120s respectively shown in FIGS. 27 to 33, a notation is the same as that in the legend in FIG. 27. In these examples, a color filter may not be arranged in a SPAD pixel 20b. In these examples, pixel information at the position of the SPAD pixel 20b may be generated from pixel information of a PD pixel 20a around the SPAD pixel 20b, as described below. For example, the imaging device 100 may generate a color output signal corresponding to the position of a SPAD pixel from a PD pixel, which is around the SPAD pixel and in which a color filter is arranged.

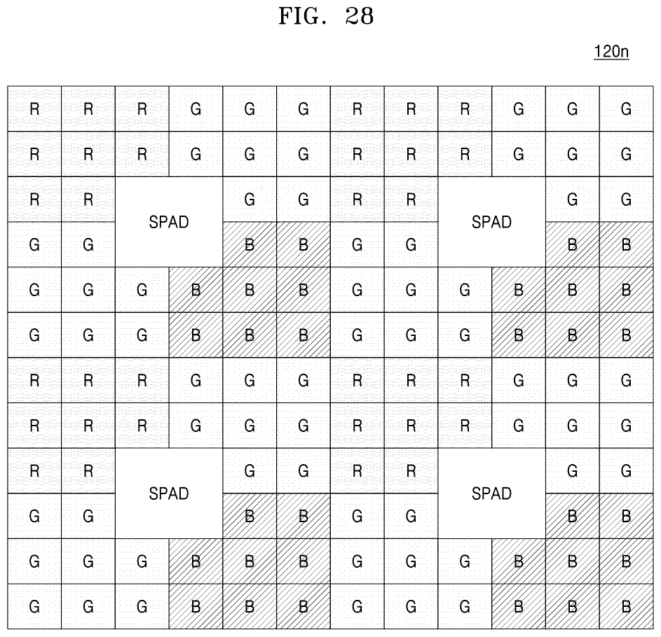

In the example of FIG. 27, a SPAD pixel 20b-12 may be divided into four pixels d1 to d4 (e.g., sub-pixels) based on the position information and the size of the SPAD pixel 20b-12, and the pixel information of each of the pixels d1 to d4 may be created by binning (or averaging) the pixel information of surrounding PD pixels 20a. For example, the pixel d1 may be replaced with pixel information obtained by averaging pieces of pixel information (or output signals) obtained after correction carried out by performing a noise reduction operation on three adjacent PD pixels 20a corresponding to R color. In the same manner, the pixel d2 may be replaced with pixel information obtained by averaging pieces of pixel information (or output signals) obtained after correction carried out by performing a noise reduction operation on three adjacent PD pixels 20a corresponding to G color. The pixels d3 and d4 may also be replaced with pixel information of G color and B color, respectively, each being obtained by averaging pieces of pixel information of surrounding pixels, in the same manner as that described above. Accordingly, even when colorless SPAD pixels 20b are provided, an image may be generated without a significant decrease in resolution. The examples in which pieces of pixel information of three PD pixels 20a are simply averaged are described above, but in examples such as FIG. 28, weights may be assigned to pieces of pixel information according to a distance ratio when the pieces of pixel information are binned.

FIG. 34 is a diagram illustrating the relationship between an output signal of a pixel and a noise reduction operation in a low-illuminance imaging environment, according to an embodiment.

Signals related to an imaging device according to an embodiment are described with reference to FIG. 34. In the embodiment of FIG. 34, illuminance may be sensed or detected based on the output signal of a SPAD pixel 20b. In the case of low illuminance, the exposure time of a PD pixel 20a may be increased compared to cases other than the low illuminance. The exposure time (or frame rate) of the SPAD pixel 20b may be constant. Therefore, at a certain low illuminance, the pixel signal adjustment operation circuit 27 may adjust the exposure time of the PD pixel 20a to be longer than the exposure time of the SPAD pixel 20b. In medium to high illuminance other than the low illuminance, the exposure time of the SPAD pixel 20b may be the same as that of the PD pixel 20a.

As shown in (a) of FIG. 34, the exposure time may be increased at low illuminance. For example, the exposure time may be several times, e.g., two to four times, longer than usual. Accordingly, the influence of noise of the PD pixel 20a at low illuminance may be reduced. Similar to the embodiments of FIGS. 1 and 20, the pixel signal adjustment operation circuit 27 may perform a noise reduction operation according to illuminance by using the PD pixel output signal V10 of the PD pixel 20a and the SPAD pixel output signal V20 ((b) of FIG. 34) of the SPAD pixel 20b corresponding to the PD pixel 20a. Here, the noise reduction operation may be performed using the SPAD pixel output signal V20 of the frame of the SPAD pixel 20b, the exposure of which simultaneously starts as the start time of the exposure of the PD pixel 20a, but the SPAD pixel output signal V20 of another frame within the exposure time of the PD pixel 20a may be used. Thereafter, frame interpolation may be performed on the output signal V10 of the PD pixel 20a, which results from the noise reduction operation, by referring to the SPAD pixel output signal V20 of the SPAD pixel 20b so that the corrected output signal V50 may be generated ((c) of FIG. 34). By performing frame interpolation using the SPAD pixel output signal V20 of a SPAD pixel having high temporal resolution, higher precision frame interpolation may be possible compared to frame interpolation using only the output signal of a PD pixel.

As described above, in the embodiment of FIG. 34, the influence of noise of the PD pixel 20a may be reduced by increasing the exposure time at low illuminance. Accordingly, in the embodiment of FIG. 34, the noise reduction coefficient rn may be increased at low illuminance compared to the embodiment of FIG. 1 and the embodiment of FIG. 20. Through this, a weight for the PD pixel 20a at low illuminance may be increased in the embodiment of FIG. 1 and the embodiment of FIG. 20 so that the decrease of resolution may be prevented even at low illuminance. In addition, with regard to PD pixels, power consumption may be reduced by lowering a read rate or a frame rate. Even when a frame rate for PD pixels is lowered, SPAD pixel information may not lower the frame rate so that temporal resolution may be maintained.

FIG. 35 is a diagram illustrating the relationship between an output signal of a pixel and a noise reduction operation in a low-illuminance imaging environment, according to an embodiment.

Signals related to an imaging device according to an embodiment is described with reference to FIG. 35. In the embodiment of FIG. 35, illuminance may be sensed based on the output signal of a SPAD pixel 20b, and in the case of low illuminance, the output signals of PD pixels 20a may be averaged by moving averaging.

In an example of (a) of FIG. 35, moving averaging may be performed with the number of sections n=4. For example, the signal of a fifth frame may use data obtained by averaging output signals of first to fourth consecutive frames immediately before the fifth frame. In addition, the signal of a sixth frame may use data obtained by averaging output signals of the second to fifth consecutive frames immediately before the sixth frame.

In the embodiment of FIG. 35, when averaged data resulting from moving averaging is used at low illuminance, responsiveness to movement may be low, but the influence of the noise of a PD pixel 20a may be reduced. Accordingly, similar to the embodiment of FIG. 34, in the embodiment of FIG. 34, the noise reduction coefficient rn may be increased at low illuminance compared to the embodiment of FIG. 1 and the embodiment of FIG. 20. Accordingly, a weight for the PD pixel 20a at low illuminance may be increased in the embodiment of FIG. 1 and the embodiment of FIG. 20 so that the decrease of resolution may be prevented even at low illuminance.

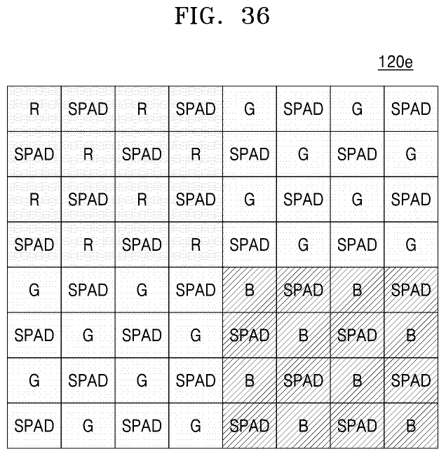

The imaging device 100 according to an embodiment is described with reference to FIGS. 36 to 39.

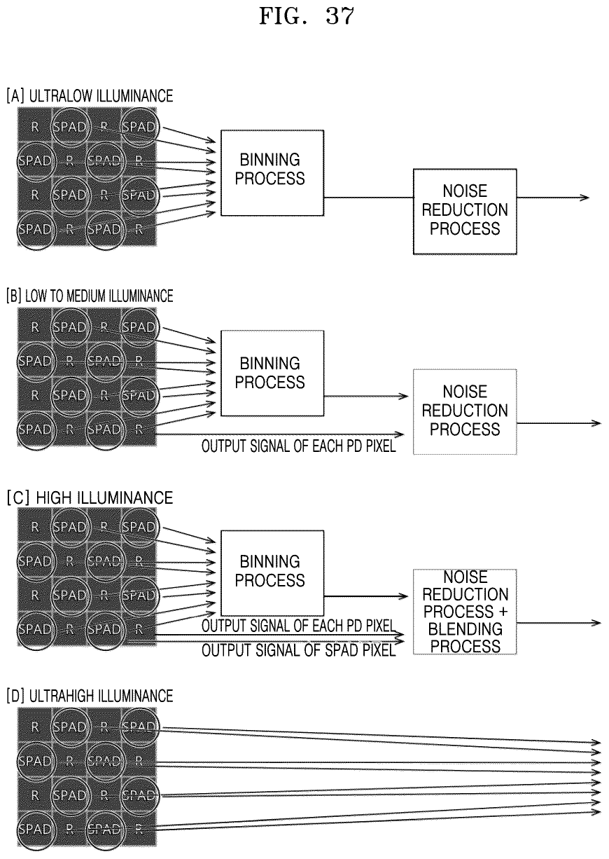

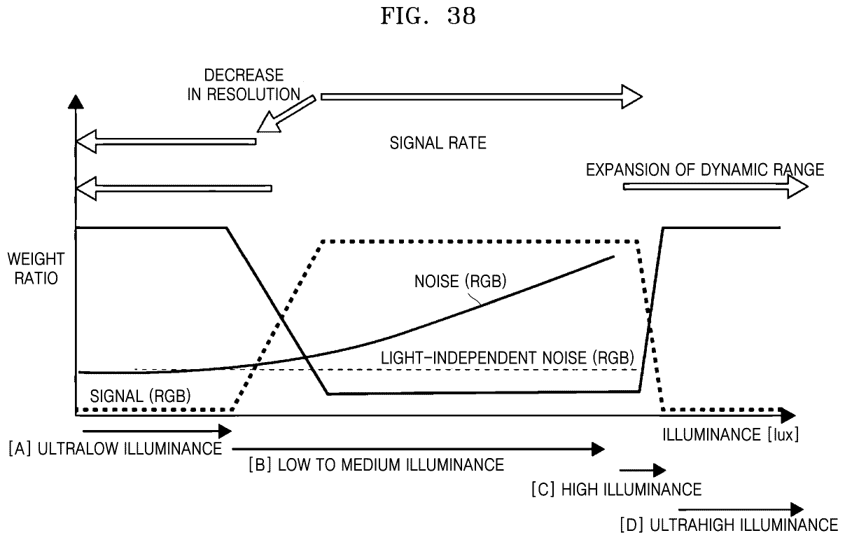

FIG. 36 is a diagram illustrating the pixel array 120e of the imaging device 100, according to an embodiment. FIG. 37 is a diagram illustrating an image generation process according to an embodiment. FIG. 38 is a diagram illustrating the usage ratio of various pixels in different illuminance.

The same numbers of PD pixels 20a and SPAD pixels 20b may be alternately arranged. The pixel array 120e of FIG. 36 may be the same as the pixel array 120c of FIG. 26, and FIG. 36 shows pixels 20 in a portion of the pixel array 120c.

According to an embodiment, in the case of ultralow illuminance, the pixel signal adjustment operation circuit 27 may not use pixel information of a PD pixel 20a but may use pixel information of only a SPAD pixel 20b. Although only R color is shown in FIG. 37 and pixels 20 corresponding to B color and G color are not shown, the same process may also be applied to B color and G color. Here, the ultralow illuminance may refer to the first half of a low illuminance range or a range in which the noise reduction coefficient rn is set to 0.0 (see (a) of FIG. 6).

As shown in [A] of FIG. 37, the pixel signal adjustment operation circuit 27 may perform binning on output signals of SPAD pixels 20b, thereby generating one output signal of R color. Accordingly, one piece of pixel information may be output from 16 (e.g., 4×4) pixels. In other words, resolution may be low. In this case, noise reduction processing (corresponding to a noise reduction operation) may not be performed. In FIG. 38, the horizontal axis is illuminance, and the vertical axis is weight ratio. The weight ratio may correspond to the noise reduction coefficient rn. As shown in FIG. 38, in the case of ultralow illuminance, the output signal (expressed as R, G, or B) of a PD pixel may not be used, but only the output signal of a SPAD pixel may be used.

As shown in [B] of FIG. 37, in the case of low illuminance (higher than the ultralow illuminance) to medium illuminance, the pixel signal adjustment operation circuit 27 may perform noise reduction processing on the output signal resulting from the binning process of the output signals of the SPAD pixels 20b and the output signal of the PD pixel 20a. The range of the binning process of SPAD pixels is not limited to eight pixels and may be changed (into four pixels or two pixels) according to illuminance. The output signal resulting from the binning process of the SPAD pixels 20b may also be used as image information. As shown in FIG. 38, in the case of low to medium illuminance, the weight ratio of the output signal of the PD pixel 20a may be gradually increased as the illuminance increases. Accordingly, resolution may gradually increase.

In the case of high illuminance, as shown in [C] of FIG. 37, the pixel signal adjustment operation circuit 27 may perform noise reduction processing on the output signal resulting from the binning process of the output signals of the SPAD pixels 20b and the output signal of the PD pixel 20a. In addition, when a ratio, at which the pixel information of a SPAD pixel 20b that has not undergone binning is blended with the pixel information of SPAD pixels 20b that has undergone binning, is increased, the output signal of each SPAD pixel 20b that underwent blending may also be used as image information. Accordingly, high-resolution image processing may be possible.

As shown in [D] of FIG. 37, in the case of ultrahigh illuminance, the pixel signal adjustment operation circuit 27 may create an image by using only SPAD pixels 20b. Here, the ultrahigh illuminance may refer to a range in which a PD pixel saturates or a high illuminance range in which the noise reduction coefficient rn is set to 0.0 (see (a) of FIG. 6). As a result, a dynamic range may be expanded to a region in which illuminance information is not obtainable with a PD pixel 20a alone due to charge saturation.

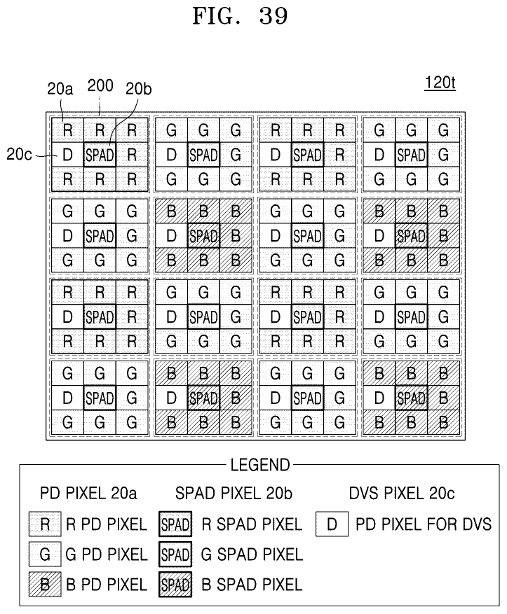

An imaging device according to an embodiment is described with reference to FIGS. 39 to 42. In an embodiment, a pixel array 120t may further include a PD pixel 20c used as a dynamic vision sensor (DVS) in addition to PD pixels 20a respectively for R, G, and B and a SPAD pixel 20b. The PD pixel 20c used as a DVS may detect an event, which is caused by a temporal change in light, i.e., movement of an object, through a circuit configuration and may output a detection signal corresponding to the event. For example, the difference between the output signal of a previous frame and the output signal of a current frame may be calculated, and an event detection signal may be output when the difference is at least a certain value.

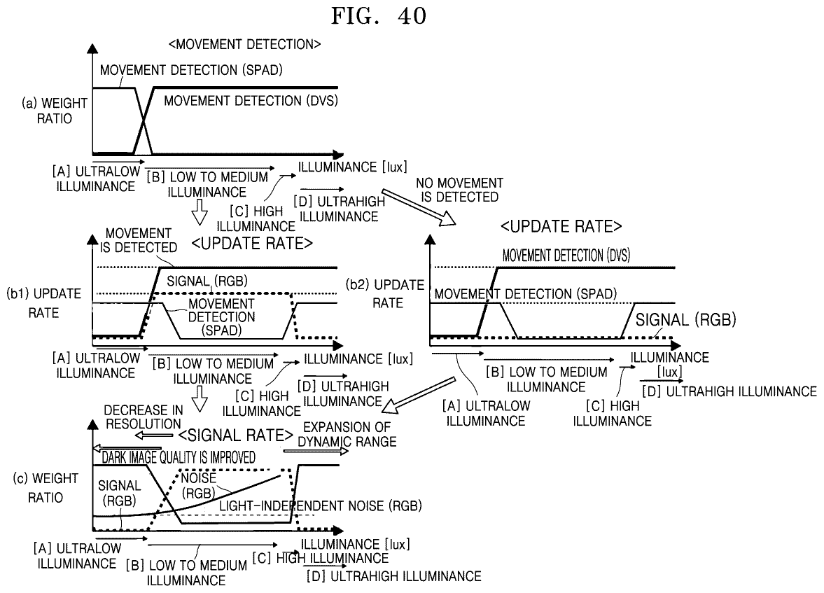

In general, the update rate (or frame rate) of a DVS is set higher than the update rate of the PD pixels 20a for RGB. In the embodiments described below, in the case of medium-low illuminance or higher, the update rate of the PD pixel 20c used as a DVS may be set higher than the update rate of the PD pixels 20a for RGB (see (b1) of FIG. 40 described below). In the case of low illuminance, the PD pixel 20c for a DVS may not be used as a DVS, and the SPAD pixel 20b may take charge of that function. The SPAD pixel 20b may be used not only for movement detection but also for image processing and noise reduction processing of a PD pixel 20a.

FIG. 39 is a diagram illustrating a pixel array of an imaging device, according to an embodiment.

The pixel array 120t may include the PD pixels 20a for RGB, the SPAD pixel 20b, and the PD pixel 20c for a DVS (hereinafter, simply referred to as a DVS pixel 20c and marked with D in FIG. 39). DVS pixels may be arranged at equal intervals throughout the pixel array 120t to be adjacent to PD pixels for RGB. In addition, the influence range of an event detected by the DVS pixel 20c may be reflected in exposure control of PD pixels 20a included in a pixel block including the DVS pixel 20c.

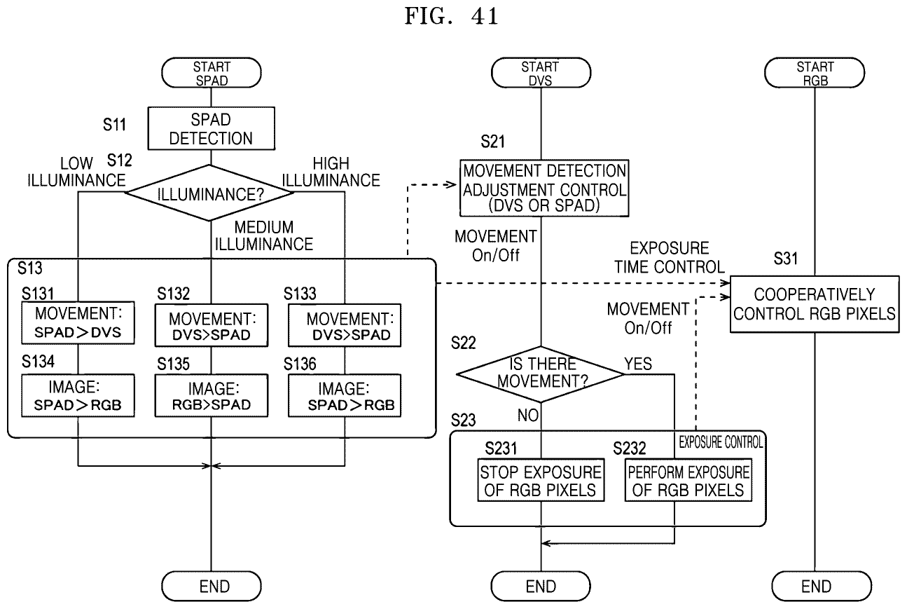

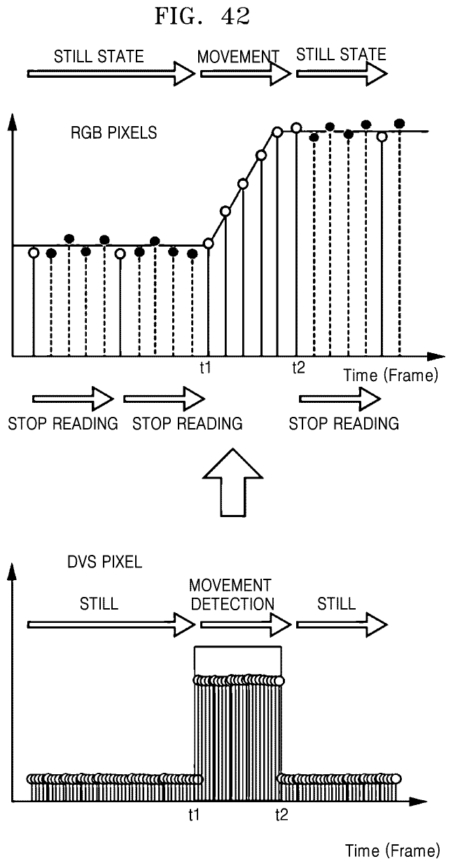

FIG. 40 is a diagram illustrating the usage ratio of each pixel used for movement sensing and update rate determination, according to an embodiment. FIG. 41 is a flowchart of a process according to an embodiment. FIG. 42 is a diagram illustrating a process of changing a frame rate according to event detection.

Operations S11 to S13 may correspond to a process performed based on the output signal of a SPAD pixel 20b. Referring to FIG. 41, the pixel signal adjustment operation circuit 27 may determine illuminance by detecting the SPAD pixel 20b. Specifically, the low illuminance, the medium illuminance, and the high illuminance of the SPAD pixel 20b may be distinguished from one another. A certain low illuminance, a certain medium illuminance, and a certain high illuminance may have the same ranges described with reference to FIG. 4A but are not limited thereto and may be set to second certain ranges different therefrom.

The pixel signal adjustment operation circuit 27 may set movement detection, an update rate, and pixel generation (or a compression rate) according to illuminance in operation S13. Operation S13 may include operations S131 to S136.

In a process of operations S131 to S133, the pixel signal adjustment operation circuit 27 may detect movement by preferentially using the signal of the SPAD pixel 20b over the signal of the DVS pixel 20c at the low illuminance, as shown in (a) of FIG. 40. The pixel signal adjustment operation circuit 27 may detect movement by preferentially using the signal of the DVS pixel 20c over the signal of the SPAD pixel 20b at the medium illuminance. The pixel signal adjustment operation circuit 27 may detect movement by preferentially using the signal of the DVS pixel 20c over the signal of the SPAD pixel 20b at the high illuminance. Here, a result of the determination may be provided for a process of operation S21.

In operations S134 to S136, the pixel signal adjustment operation circuit 27 may give priority to the SPAD pixel 20b over RGB pixels, i.e., PD pixels 20a, when detecting a signal at the low illuminance, as shown in (c) of FIG. 40, (for example, the pixel signal adjustment operation circuit 27 may set the noise reduction coefficient rn to be less than 0.5). The pixel signal adjustment operation circuit 27 may give priority to the RGB pixels, i.e., the PD pixels 20a, over the SPAD pixel 20b, when detecting a signal at the medium illuminance (for example, the pixel signal adjustment operation circuit 27 may set the noise reduction coefficient rn to exceed 0.5). The pixel signal adjustment operation circuit 27 may give priority to the SPAD pixel 20b over the RGB pixels, i.e., the PD pixels 20a, when detecting a signal at the high illuminance (for example, the pixel signal adjustment operation circuit 27 may set the noise reduction coefficient rn to be less than 0.5). The process described above may be the same as the noise reduction process described with reference to FIGS. 3 to 6 above.

Operations S21 to S23 may be performed based on an output signal of the DVS pixel 20c. The pixel adjustment control circuit 28 may perform movement detection adjustment control in operation S21. As shown in (a) of FIG. 40, an event may be detected using signals of one or both of the DVS pixel 20c and the SPAD pixel 20b according to illuminance.

The pixel adjustment control circuit 28 may perform an exposure control process, in which the exposure of RGB pixels is controlled, in operation S23 based on a result of determining whether movement is detected in operation S22. In operation S231, the pixel adjustment control circuit 28 may reduce power consumption by stopping the exposure of the RGB pixels, i.e., the PD pixels 20a, or decreasing a frame rate according to a result of determining that movement has not been detected. The process described above is illustrated in (b2) of FIG. 40.

In operation S232, the pixel adjustment control circuit 28 may perform exposure of the RGB pixels, i.e., the PD pixels 20a, according to a result of determining that an event, i.e., movement, has been detected. The process described above is illustrated in (b1) of FIG. 40. In the case of the medium illuminance, exposure of the RGB pixels, i.e., the PD pixels 20a, may be performed at a normal frame rate. In the case of the low illuminance or the high illuminance, exposure may be performed at a frame rate lower than the normal frame rate or may be stopped. Because a SPAD pixel and RGB pixels operate in coordination (or cooperatively) with each other only in a movement detection region of the DVS pixel 20c, power consumption may be realized.

The same noise reduction process as that in the embodiment of FIG. 1 may be performed on the output signals of the RGB pixels, i.e., the PD pixels 20a, in operation S31. The pixel adjustment control circuit 28 may control the exposure of the pixel adjustment control circuit 28 according to the result of the movement detection determination in operation S13 and the result of determining the update rate in operation S23. This process is illustrated in (b1), (b2), and (c) of FIG. 40.

Although the exposure of the RGB pixels, i.e., the PD pixels 20a, is stopped when there is no movement in the embodiment described with reference to FIGS. 39 to 41, the frame rate of the RGB pixels, i.e., the PD pixels 20a, may be decreased in the example of FIG. 42. In the example of FIG. 42, when movement is determined to exist as the result of the event detection by the DVS pixel 20c, exposure and reading may be performed at a normal frame rate (e.g., 60 fps). When there is no movement and “still” is determined, a frame rate (e.g., 15 or 12 fps) that is lower than the normal frame rate may be set. For example, based on the determination result indicating “still”, a frame rate that is several times lower than the normal frame rate may be set. Accordingly, power consumption may be reduced without an influence on image quality.

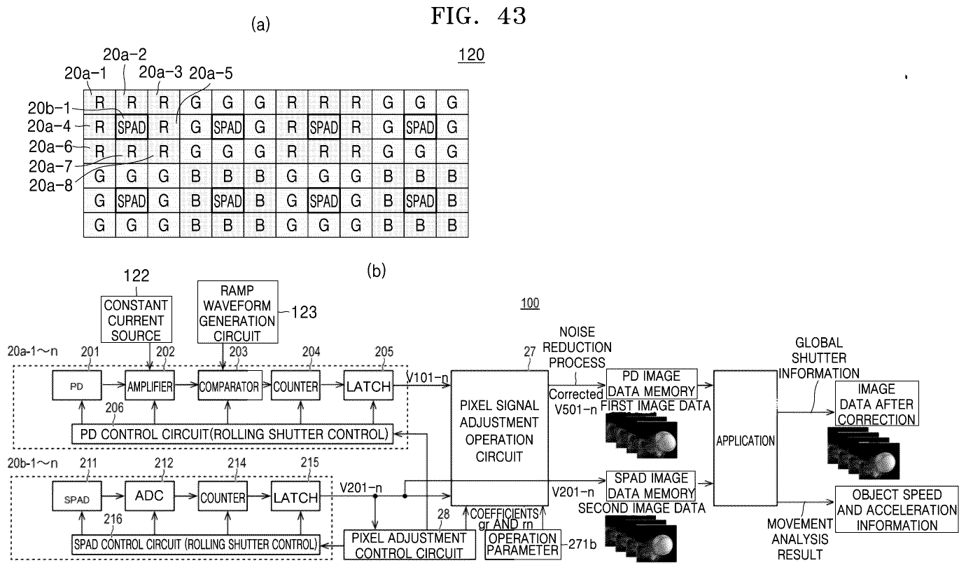

FIG. 43 is a diagram illustrating the imaging device 100 and the pixel array 120, according to an embodiment.

The imaging device 100 according to an embodiment is described with reference to FIG. 43. In the embodiment of FIG. 43, the arrangement of PD pixels 20a and SPAD pixels 20b in the pixel array 120 may be the same as those in the respective embodiments of FIGS. 1 and 20. For example, the arrangement may be the same as that in (a) of FIG. 43. (b) of FIG. 43 is a block diagram of the imaging device 100 according to an embodiment. With respect to all the PD pixels 20a of the pixel array 120, imaging may be performed by a rolling shutter method, in which exposure and signal charge reading are sequentially performed row-by-row by the vertical scanning unit 130 (see FIG. 1) to collect output signals. With respect to all the SPAD pixels 20b of the pixel array 120, imaging may be performed by a global shutter method, in which the same start and end of an exposure period are used. The noise reduction process using the output signal of a SPAD pixel 20b, which has been described with reference to FIG. 1, may be performed on each of the PD pixels 20a by the pixel signal adjustment operation circuit 27.

In the embodiment of FIG. 43, first image data, which is generated by the rolling shutter method based on the output signals of the PD pixels 20a-1 to 20a-n that have been corrected by the noise reduction process, may be stored in PD pixel data memory. Second image data, which is generated by the global shutter method based on the output signals of the SPAD pixels 20b-1 to 20b-n, may be stored in SPAD pixel data memory.

An application may correct the first image data to be equivalent to an image obtained using the global shutter method (hereinafter referred to as rolling shutter correction) based on a pair of the first image data and the second image data, which are obtained by simultaneous imaging, thereby generating corrected image data. The application may also calculate the speed and the acceleration of an object in an image based on the speed of a rolling shutter for a PD pixel 20a and information of the first image data and the second image data. A result of the calculation may be output as object speed and acceleration information. FIG. 43 illustrates an example in which the noise reduction process is performed by the pixel signal adjustment operation circuit 27, but this may be omitted. Specifically, the application may perform rolling shutter correction using the first image data generated from the output signal of the PD pixel 20a, which has not undergone a noise reduction process, and the second image data generated from the output signal of a SPAD pixel 20b.

As described above, in the embodiment of FIG. 43, the first image data may be generated from the SPAD pixel using the global shutter method, the second image data maybe generated from the PD pixel using the rolling shutter method, and rolling shutter correction may be performed on the second image data based on the first image data and the second image data, which are simultaneously imaged. Accordingly, it may possible to correct distortion that occurs in a moving object or the like in the rolling shutter method.

In the present embodiment, the imaging device may include a pixel signal adjustment operation circuit, which generates a corrected output signal of each PD pixel by performing a noise reduction operation according to illuminance based on the output signal of a PD pixel and the output signal of a SPAD pixel corresponding to the PD pixel. As a result, satisfactory image quality characteristics may be obtained in imaging under shooting conditions ranging from low illuminance to high illuminance.

In addition, in the imaging device of the present embodiment, one PD pixel may correspond to a plurality of SPAD pixels, and the pixel signal adjustment operation circuit may generate a corrected output signal of the PD pixel by performing a noise reduction operation according to illuminance based on the output signals of the SPAD pixels corresponding to the PD pixel. The pixel signal adjustment operation circuit may also generate an integrated output signal that integrates the output signals of a plurality of SPAD pixels by using a distance ratio based on position information of a PD pixel to be corrected and position information of each of the SPAD pixels. The pixel signal adjustment operation circuit may also generate a corrected output signal of the PD pixel to be corrected by performing a noise reduction operation according to illuminance based on the output signal of the PD pixel and the integrated output signal. As a result, a noise reduction process may be performed with high precision so that satisfactory image quality characteristics may be obtained.

In the imaging device of the present embodiment, the pixel signal adjustment operation circuit may generate a corrected output signal of a PD pixel by using the output signal of a SPAD pixel at a higher rate than the output signal of the PD pixel when illuminance is a certain low illuminance. Accordingly, image information having reduced noise and a high SNR may be obtained.

In the imaging device of the present embodiment, the pixel signal adjustment operation circuit may generate a corrected output signal of a PD pixel by using the output signal of the PD pixel at a higher rate than the output signal of a SPAD pixel in the case of a certain medium illuminance. Accordingly, high-resolution image information may be obtained.

In the imaging device of the present embodiment, the pixel signal adjustment operation circuit may generate a corrected output signal of a PD pixel by using the output signal of a SPAD pixel at a higher rate than the output signal of the PD pixel in the case of a certain high illuminance. Accordingly, image information having a high dynamic range may be obtained.

In the imaging device of the present embodiment, the pixel signal adjustment operation circuit may set the exposure time of a PD pixel to be longer than the exposure time of a SPAD pixel when illuminance is a certain low illuminance. Accordingly, the noise of the PD pixel may be reduced in low illuminance so that an SNR may be further increased. In addition, when a noise reduction rate is decreased by increasing resolution instead of increasing the SNR, the decrease of resolution may be suppressed.

In the imaging device of the present embodiment, the pixel signal adjustment operation circuit may use the moving average of a plurality of consecutive frames of a PD pixel as the output signal of the PD pixel. Accordingly, the noise of the PD pixel may be reduced at low illuminance, and the decrease of resolution may be suppressed.

When an event is detected in the imaging device of the present embodiment, the pixel signal adjustment operation circuit may generate a corrected output signal of each PD pixel by performing noise reduction operation according to illuminance based on the output signal of the PD pixel and the output signal of a SPAD pixel corresponding to the PD pixel. Accordingly, power consumption may be decreased without an influence on image quality.

According to the above description, a method of correcting an output signal of an imaging device can be realized. For example, a method of generating an image captured by an imaging device includes generating a first output signal by a first photodiode (PD) pixel of a pixel array based on light received by the first PD pixel, generating a second output signal by a first single-photon avalanche diode (SPAD) pixel of the pixel array based on light received by the first SPAD pixel; and generating a corrected output signal of the first PD pixel by performing a noise reduction operation according to illuminance, based on the output signal of the first PD pixel and the output signal of the first SPAD pixel. The noise reduction operation may be based on an equation such as Equation 1 discussed above. For example, the method may include selecting a first noise reduction coefficient lower than a threshold value when the illuminance is below a first threshold, in order to generate a first corrected output signal, may include selecting a second noise reduction coefficient lower than the threshold value when the illuminance is above a second threshold, in order to generate a second corrected output signal, and may further include selecting a third noise reduction coefficient equal to or higher than the threshold value when the illuminance is above the first threshold and below the second threshold, in order to generate a third corrected output signal. For example, the each of the first noise reduction coefficient, the second noise reduction coefficient, and the third noise reduction coefficient may be used to multiply a signal derived from the first output signal and the second output signal. Example first through third illuminance thresholds as well as example noise reduction coefficient threshold values can be seen, for example, in FIG. 6.

According to an embodiment, the pixel array further includes a plurality of DVS pixels arranged at equal intervals throughout the pixel array, and each of the plurality of DVS pixels is adjacent to a respective PD pixel.

According to an embodiment, the method further comprises selecting a first noise reduction coefficient lower than a threshold value when the illuminance is below a first threshold, in order to generate a first corrected output signal.

According to an embodiment, the method further comprises selecting a second noise reduction coefficient lower than the threshold value when the illuminance is above a second threshold, in order to generate a second corrected output signal.

According to an embodiment, the method further comprises selecting a third noise reduction coefficient equal to or higher than the threshold value when the illuminance is above the first threshold and below the second threshold, in order to generate a third corrected output signal.

According to an embodiment, the each of the first noise reduction coefficient, the second noise reduction coefficient, and the third noise reduction coefficient is used to multiply a signal derived from the first output signal and the second output signal.

The main configurations of the imaging device 100 or the like described above have been described in the embodiments. The embodiments are not limited to the configurations described above, and various modifications may be made in the embodiment within the scope of the following claims. In addition, configurations including general solid-state imaging devices are not excluded.

While the inventive concept has been particularly shown and described with reference to embodiments thereof, it will be understood that various changes in form and details may be made therein without departing from the spirit and scope of the following claims.

What is claimed is:

1. An imaging device comprising:
a pixel array including a first photodiode (PD) pixel and a first single-photon avalanche diode (SPAD) pixel corresponding to the PD pixel; and
a pixel signal adjustment operation circuit configured to generate a corrected output signal of the first PD pixel by performing a noise reduction operation according to illuminance, based on an output signal of the first PD pixel and an output signal of the first SPAD pixel.

2. The imaging device of claim 1, wherein:
a plurality of SPAD pixels including the first SPAD pixel correspond to the first PD pixel, and
the pixel signal adjustment operation circuit is further configured to generate the corrected output signal of the first PD pixel by performing a noise reduction operation according to illuminance, based on output signals of the plurality of SPAD pixels corresponding to the first PD pixel.

3. The imaging device of claim 2, wherein:
the pixel signal adjustment operation circuit is further configured to:
generate an integrated output signal integrating the output signals of the plurality of SPAD pixels by using a distance ratio based on position information of the first PD pixel and position information of each of the plurality of SPAD pixels, and
generate the corrected output signal of the first PD pixel by performing a noise reduction operation according to illuminance, based on the output signal of the PD pixel and the integrated output signal.

4. The imaging device of claim 1, wherein:
the pixel signal adjustment operation circuit is further configured to generate the corrected output signal of the first PD pixel by using the output signal of the first SPAD pixel at a higher rate than the output signal of the first PD pixel when the illuminance is a low illuminance.

5. The imaging device of claim 4, wherein:
the pixel signal adjustment operation circuit is further configured to generate the corrected output signal of the first PD pixel by using the output signal of the first PD pixel at a higher rate than the output signal of the first SPAD pixel when the illuminance is a medium illuminance that is higher than the low illuminance.

6. The imaging device of claim 5, wherein:
the pixel signal adjustment operation circuit is further configured to generate the corrected output signal of the first PD pixel by using the output signal of the first SPAD pixel at a higher rate than the output signal of the first PD pixel when the illuminance is a certain high illuminance that is higher than the medium illuminance.

7. The imaging device of claim 1, wherein:
the pixel signal adjustment operation circuit is further configured to calculate the corrected output signal of the first PD pixel according to Equation 1 using a noise reduction coefficient according to the illuminance:
$$V 50 = ( ( V 10 \times gr - V 20 ) \times rn + V 20 ) / gr , \qquad [ Equation 1 ]$$
wherein V50 is the corrected output signal, V10 is an output signal value of the first PD pixel, V20 is an output signal value of the first SPAD pixel, gr is a gain coefficient used to match scales of the output signals, and rn is the noise reduction coefficient,
wherein the noise reduction coefficient rn is set to be lowest at low illuminance and at high illuminance and highest at medium illuminance between the low illuminance and the high illuminance and set to gradually increase as illuminance increases from the low illuminance to the high illuminance and gradually decrease as illuminance increases from the medium illuminance to the high illuminance.

8. The imaging device of claim 1, wherein:
the pixel signal adjustment operation circuit is further configured to set an exposure time of the first PD pixel to be longer than an exposure time of the first SPAD pixel when the illuminance is a low illuminance.

9. The imaging device of claim 1, wherein:
the pixel signal adjustment operation circuit is further configured to use a moving average of a plurality of consecutive frames of the first PD pixel as the output signal of the first PD pixel when the illuminance is a low illuminance.

10. The imaging device of claim 1, wherein the noise reduction operation is carried out by a bit shift operation.

11. The imaging device of claim 1, wherein:
a plurality of SPAD pixels including the first SPAD pixel correspond to the first PD pixel, and
the pixel signal adjustment operation circuit is further configured to generate the corrected output signal of the first PD pixel by performing a noise reduction operation according to illuminance, based on a binned output signal of the plurality of SPAD pixels corresponding to the first PD pixel.

12. The imaging device of claim 11, wherein:
the pixel signal adjustment operation circuit is further configured to output pixel information by blending the binned output signal of the plurality of SPAD pixels with an output signal of each of the plurality of SPAD pixels that has not undergone binning.

13. The imaging device of claim 1, wherein:
the pixel array further includes a dynamic vision sensor (DVS) pixel for event detection, and
when an event is detected, the pixel signal adjustment operation circuit is further configured to generate the corrected output signal of the first PD pixel by performing a noise reduction operation according to illuminance, based on the output signal of the first PD pixel and the output signal of the first SPAD pixel corresponding to the first PD pixel.

14. The imaging device of claim 13, wherein:
the pixel signal adjustment operation circuit is further configured to detect the event by using the output signal of the first SPAD pixel and an output signal of the DVS pixel at a ratio according to the illuminance.

15. The imaging device of claim 14, wherein:
the pixel signal adjustment operation circuit is further configured to detect the event by using the output signal of the first SPAD pixel at a higher rate than the output signal of the DVS pixel when the illuminance is a second low illuminance.

16. The imaging device of claim 15, wherein:
the pixel signal adjustment operation circuit is further configured to detect the event by using the output signal of the DVS pixel at a higher rate than the output signal of the first SPAD pixel or by using only the output signal of the DVS pixel when the illuminance is higher than the second low illuminance.

17. The imaging device of claim 1, wherein:
a color filter is not arranged at a position of the first SPAD pixel in the pixel array, and
pixel information of the first SPAD pixel is generated from pixel information of the first PD pixel around the first SPAD pixel, wherein a color filter is arranged in the first PD pixel.

18. The imaging device of claim 1, wherein:
first image data is generated from the first SPAD pixel using a global shutter method,
second image data is generated from the first PD pixel using a rolling shutter method, and
rolling shutter correction is performed on the second image data based on the first image data and the second image data, which are simultaneously imaged.

19. The imaging device of claim 1, wherein:
the pixel array further includes a plurality of SPAD pixels that include the first SPAD pixel and are arranged at equal intervals throughout the pixel array, and each of the plurality of SPAD pixels is adjacent to a PD pixel.

20. A method of generating an image captured by an imaging device, comprising:
generating a first output signal by a first photodiode (PD) pixel of a pixel array based on light received by the first PD pixel;
generating a second output signal by a first single-photon avalanche diode (SPAD) pixel of the pixel array based on light received by the first SPAD pixel; and
generating a corrected output signal of the first PD pixel by performing a noise reduction operation according to illuminance, based on the first output signal of the first PD pixel and the second output signal of the first SPAD pixel.
